(19) United States
(12) Patent Application Publication
(10) Pub. No.: US 2024/0346406 A1
(43) Pub. Date: Oct. 17, 2024

(54) RECRUITMENT SUPPORT APPARATUS, RECRUITMENT SUPPORT METHOD, AND RECORDING MEDIUM

(71) Applicant: NEC Corporation, Minato-ku, Tokyo (JP)

(72) Inventors: Yoji Mori, Tokyo (JP); Ayako Hoshino, Tokyo (JP); Yuya Endo, Tokyo (JP); Yuuki Watanabe, Tokyo (JP); Naruto Yajima, Tokyo (JP)

(73) Assignee: NEC Corporation, Minato-ku, Tokyo (JP)

(21) Appl. No.: 18/682,490

(22) PCT Filed: Sep. 15, 2021
(86) PCT No.: PCT/JP2021/033835

§ 371 Date: Feb. 9, 2024

(51) Int. Cl. G06Q 10/0631

(52) U.S. Cl. CPC G06Q 10/063112

(57) ABSTRACT

In order to suitably carry out personnel assistance, a recruitment assistance apparatus (1) includes: a reception section (11) for receiving a request pertaining to a place of assignment of a subject staff; an inference section (12) for inferring a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and an output section (13) for outputting information indicating the candidate place of assignment which has been inferred by the inference section.

### TECHNICAL FIELD

The present invention relates to a recruitment assistance apparatus and the like for assisting personnel work.

### BACKGROUND ART

Conventionally, a technique for assisting personnel work by an information processing apparatus has been studied. For example, Patent Literature 1 below discloses an information processing apparatus that outputs photographic data of a worker, and that generates a reference model for personal evaluation while using, as a model, a subject selected from the output photographic data.

According to the technique of Patent Literature 1, for example, it is possible to carry out high performer analysis that analyzes a worker of high performance, low performer analysis that analyzes a worker of low performance, absentee analysis that analyzes a worker who takes leave of absence, resignee analysis that analyzes a worker who quits work, and the like. By evaluating a candidate to be recruited while using such a technique, it is possible to recruit a person who is more likely to be a worker of high performance.

### CITATION LIST

### Patent Literature

### [Patent Literature 1]

Japanese Patent Application Publication Tokukai No. 2021-39777

### SUMMARY OF INVENTION

### Technical Problem

However, there are many cases in which even a person who has excellent ability is not congenial to a department, work contents, a supervisor, and/or a colleague at a place where the person is hired, and takes leave of absence or quit working without demonstrating his/her capabilities. Although it is possible to carry out absentee analysis and resignee analysis with the technique of Patent Literature 1, leave of absence and resignation are greatly affected by congeniality to an acceptance place as described above, as well as by personal qualities. Therefore, it is not necessarily the case that a person will work continuously who has been evaluated to be difficult to take leave of absence or to quit working by the absentee analysis or the resignee analysis in Patent Literature 1. Such circumstances are not limited to staff recruitment, and apply also to reallocation of workers, team formation, and the like in an organization.

An example aspect of the present invention is accomplished in view of the above problem, and an example object thereof is to provide a technique for suitably carrying out personnel assistance while taking into consideration various kinds of information pertaining to an acceptance place where a staff is to be accepted.

### Solution to Problem

A recruitment assistance apparatus in accordance with an example aspect of the present invention includes: a reception means for receiving a request pertaining to a place of assignment of a subject staff; an inference means for inferring a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and an output means for outputting information indicating the candidate place of assignment which has been inferred by the inference means.

A recruitment assistance method in accordance with an example aspect of the present invention includes: receiving, by at least one processor, a request pertaining to a place of assignment of a subject staff; inferring, by the at least one processor, a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and outputting, by the at least one processor, information indicating the candidate place of assignment which has been inferred.

A recruitment assistance program in accordance with an example aspect of the present invention causes a computer to function as: a reception means for receiving a request pertaining to a place of assignment of a subject staff; an inference means for inferring a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and an output means for outputting information indicating the candidate place of assignment which has been inferred by the inference means.

### Advantageous Effects of Invention

According to an example aspect of the present invention, it is possible to suitably carry out personnel assistance while taking into consideration various kinds of information pertaining to an acceptance place where a staff is to be accepted.

### BRIEF DESCRIPTION OF DRAWINGS

FIG. 1 is a block diagram illustrating a configuration of a recruitment assistance apparatus in accordance with a first example embodiment of the present invention.

FIG. 2 is a flowchart illustrating a flow of a recruitment assistance method in accordance with the first example embodiment of the present invention.

FIG. 3 is a diagram illustrating learning of feature quantities in graph-based relationship learning.

FIG. 4 is a block diagram illustrating a configuration of a recruitment assistance apparatus in accordance with a second example embodiment of the present invention.

FIG. 5 is a schematic diagram illustrating an example of a method for generating a subject staff graph by a graph generation section in accordance with the second example embodiment of the present invention.

FIG. 6 is a schematic diagram illustrating an example of a method of prediction carried out by a link prediction section in accordance with the second example embodiment of the present invention.

FIG. 7 is a schematic diagram illustrating an example of a method for carrying out prediction by a link prediction section, an identification section, and a congeniality determination section in accordance with the second example embodiment of the present invention.

FIG. 8 is a flowchart illustrating a first process example carried out by the recruitment assistance apparatus in accordance with the second example embodiment of the present invention.

FIG. 9 is a schematic diagram illustrating another example of a method for carrying out prediction by the link prediction section, the identification section, and the congeniality determination section in accordance with the second example embodiment of the present invention.

FIG. 10 is a diagram for describing an example of a method of recommendation carried out by a recommendation section in accordance with the second example embodiment of the present invention.

FIG. 11 is a flowchart illustrating a second process example carried out by the recruitment assistance apparatus in accordance with the second example embodiment of the present invention.

FIG. 12 is a diagram illustrating an example of presentation carried out by an output section in accordance with the second example embodiment of the present invention.

FIG. 13 is a schematic diagram illustrating an example of a method of prediction carried out by a link prediction section in accordance with a third example embodiment of the present invention.

FIG. 14 is a schematic diagram illustrating another example of a method of prediction carried out by the link prediction section in accordance with the third example embodiment of the present invention.

FIG. 15 is a diagram illustrating an overview of a recruitment assistance method in accordance with a fourth example embodiment of the present invention.

FIG. 16 is a block diagram illustrating a configuration of a recruitment assistance apparatus in accordance with the fourth example embodiment of the present invention.

FIG. 17 is a flowchart illustrating a flow of a process carried out by the recruitment assistance apparatus in accordance with the fourth example embodiment of the present invention.

FIG. 18 is a diagram for describing an example in which a property of a subject staff is predicted based on a feature quantity calculated from a subject staff graph and an acceptance place graph.

FIG. 19 is a configuration diagram for realizing a recruitment assistance apparatus by software.

### EXAMPLE EMBODIMENTS

### First Example Embodiment

The following description will discuss a first example embodiment of the present invention in detail, with reference to the drawings. The present example embodiment is a basic form of example embodiments described later.

### (Recruitment Assistance Apparatus)

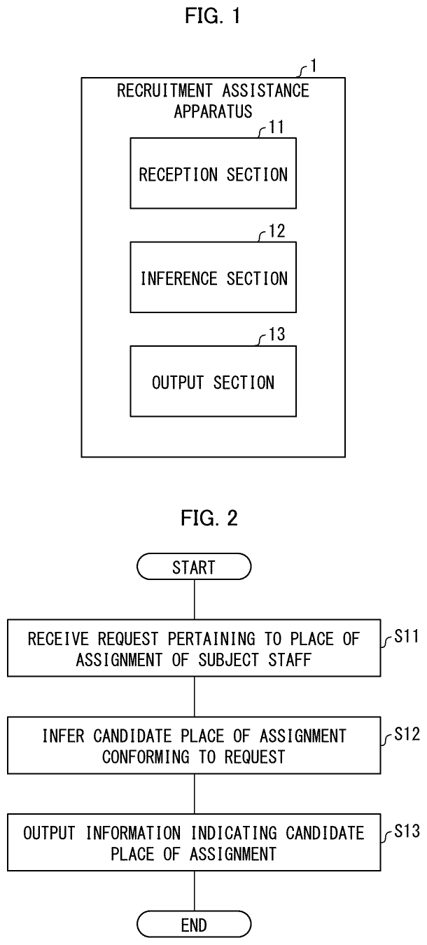

The following description will discuss a configuration of a recruitment assistance apparatus 1 in accordance with the present example embodiment, with reference to the drawings. FIG. 1 is a block diagram illustrating the configuration of the recruitment assistance apparatus 1 in accordance with the present example embodiment.

As illustrated in FIG. 1, the recruitment assistance apparatus 1 includes a reception section (reception means) 11, an inference section (inference means) 12, and an output section (output means) 13.

The reception section 11 receives a request pertaining to a place of assignment of a subject staff. Note that information pertaining to a subject staff, such as a skill and work experience of the subject staff, is information to be considered in deciding a place of assignment of the subject staff. Therefore, a request including such information is also encompassed in the scope of the request “pertaining to a place of assignment of a subject staff”. The inference section 12 infers a candidate place of assignment that conforms to the request received by the reception section 11 and that is of the subject staff with use of a learned model which has learned a relation between (i) at least one selected from the group consisting of a skill and work experience of each of a plurality of persons and (ii) an affiliation of each of the plurality of persons. The output section 13 outputs information indicating the candidate place of assignment that is of the subject staff and that has been inferred by the inference section 12.

Here, work experience of a certain person may include, but not limited to, a department to which the certain person belongs, a department to which the certain person has belonged, years of affiliation to respective departments, the order in which the certain person has belonged to departments, and the like (these are collectively referred to as affiliation history). Examples of the department include, but not limited to, a division, a section, a group, and the like.

According to the recruitment assistance apparatus 1 having the above configuration, it is possible to present, to a user, a candidate place of assignment that is of the subject staff and that can be considered to conform to the request based on a relation between (i) at least one selected from the group consisting of a skill and work experience of each of a plurality of persons and (ii) an affiliation of each of the plurality of persons. Therefore, according to the configuration, it is possible to bring about an example advantage of suitably carrying out personnel assistance for a subject staff while taking into consideration various kinds of information pertaining to an acceptance place.

### (Recruitment Assistance Program)

The functions of the recruitment assistance apparatus 1 described above can also be realized by a program. A recruitment assistance program in accordance with the present example embodiment causes a computer to carry out: a process of receiving a request pertaining to a place of assignment of a subject staff; a process of inferring a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and an output process of outputting information indicating the candidate place of assignment which has been inferred. According to the recruitment assistance program, it is possible to bring about an example advantage of suitably carrying out personnel assistance for a subject staff while taking into consideration various kinds of information pertaining to an acceptance place.

### (Recruitment Assistance Method)

The following description will discuss a recruitment assistance method in accordance with the present example embodiment, with reference to FIG. 2. FIG. 2 is a flowchart illustrating a flow of the recruitment assistance method in accordance with the first example embodiment of the present invention.

In S11, a computer receives a request pertaining to a place of assignment of a subject staff. The request may be received via an arbitrary input apparatus. For example, the request may be received via a mouse, a keyboard, a touch panel, or an audio input apparatus.

In S12, the computer infers a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons.

In S13, the computer outputs information indicating the inferred candidate place of assignment of the subject staff. The information may be output to an arbitrary apparatus. For example, the information may be output to a display apparatus so that the information is displayed, or the information may be output to an audio output apparatus so that the information is output as audio.

As described above, the recruitment assistance method in accordance with the present example embodiment includes: receiving, by a computer (at least one processor), a request pertaining to a place of assignment of a subject staff (S11); inferring, by the computer (at least one processor), a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons (S12); and outputting, by the computer (at least one processor), information indicating the candidate place of assignment which has been inferred in S12 (S13). According to the recruitment assistance method, it is possible to bring about an example advantage of suitably carrying out personnel assistance for a subject staff while taking into consideration various kinds of information pertaining to an acceptance place.

An execution subject of each step in the recruitment assistance method described above may be a single computer (e.g., the recruitment assistance apparatus 1), or execution subjects of respective steps may be different computers. The same applies to flows described later in the second and subsequent example embodiments.

### [Graph and Learning]

The following description will discuss a graph that is an example of information which can be used to assist recruitment in the first example embodiment and in the subsequent example embodiments (hereinafter, referred to as “each example embodiment”). The following description will also discuss learning of the graph and prediction using the graph.

### (Graph)

The graph herein refers to data having a structure composed of a plurality of nodes and links connecting the nodes. A type of link representing a relation between nodes is also called a “relation”. Alternatively, the link may be called an “edge”. The graph roughly includes a directed graph in which each link has directionality, and an undirected graph in which each link has no directionality. It is possible to utilize either a directed graph or an undirected graph. It is also possible to use those graphs in combination.

In a case of using a graph in each example embodiment, a node in the graph only needs to represent a tangible or intangible element pertaining to a person. For example, it is possible to utilize a graph including nodes representing various elements such as:
identification information of a person such as a name and a personal ID;
an age;
a personality;
a current type of work or desired type of work;
a current affiliation or desired place of assignment; and
a skill.
   More specifically, it is possible to utilize a graph including nodes representing various elements such as:
identification information of a person such as a name and a personal ID;
basic attributes (type of work, gender, affiliation, post, grade, and the like);
achievements and experience (work experience (including affiliation history), educational background, evaluation record, training experience, history pertaining to supervisors and subordinates, outcomes, reception records, awards and honors, and attendance record);
capabilities, skills and qualifications (skill level, language skill, holding qualifications, and the like);
mind (personality, aptitude test result, personality assessment result, carrier orientation, satisfaction survey result, interview record, supervisor memorandum, and the like);
job contents (mission, goal, work contents, and the like);
business characteristics (past contribution or possible contribution to new business, work-ready force or late bloomer, appropriate for overseas assignment or appropriate for domestic assignment, and the like); and
action data (position information, main communication partner, and the like).
   Here, information pertaining to a main communication partner can be identified based on a usage pattern of a tool such as an in-house social networking service (SNS). Note that the above-described basic attributes, capabilities, skills, qualifications, and mind may be expressed as properties. The properties may include elements other than those described above. The above-described elements may each be referred to as an attribute.

The graph may include a plurality of nodes corresponding to a single element. For example, as nodes indicating skills, skills of a person may be represented by respective individual nodes, such as a node indicating a first skill, a node indicating a second skill, and a node indicating a third skill. The same applies to other elements.

In a case where there are nodes corresponding to elements as described above, a link connecting such nodes represents:
a relation between a certain element and a person;
a relation between a certain element and an age;
a relation between a certain element and a personality;
a relation between a certain element and a desired type of work;
a relation between a certain element and a skill;
   and the like. For example, a link connecting a node indicating a personality to a node indicating an outcome may represent a relation in which the personality is a factor of the outcome.

### (Learning and Prediction)

For a graph as described above, a machine learning technique can be applied to carry out graph-based relationship learning. Such learning makes it possible to carry out a classification process or a prediction process using a graph. In each example embodiment, such learning may be carried out as a part of recruitment assistance, or a learned graph which has already been subjected to such learning may be used.

In graph-based relationship learning, first, a feature quantity of each node is calculated. The feature quantity may be calculated in, for example, a form of feature quantity vector. By representing a feature quantity of each node by a feature quantity vector, it is possible to carry out learning also for a graph in which nodes of various forms mixedly exist. For example, graph-based relationship learning can also be carried out for a graph including an image, a numerical value, and the like indicating various elements as described above. For example, a photograph of a staff can be used as a node.

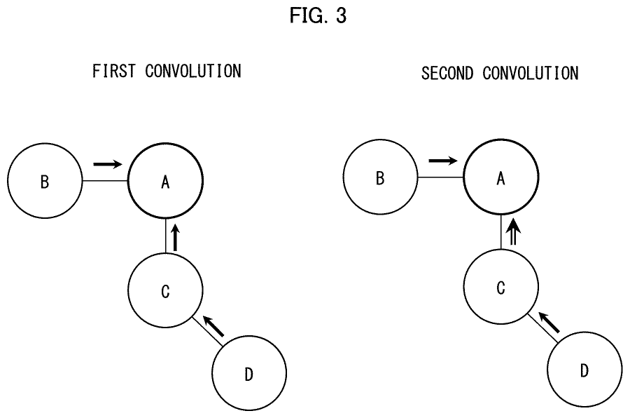

Next, the feature quantity of each node is updated based on a link connected to that node and a node which is a connection destination of the link. This process is similar to a convolution process in a convolutional neural network. This will be described with reference to FIG. 3. FIG. 3 is a diagram illustrating learning of feature quantities in graph-based relationship learning.

In a graph illustrated in FIG. 3, four nodes A through D are included. The nodes B and C are connected to the node A, and the node D is connected to the node C. After calculating initial feature quantities of these four nodes, a plurality of times of convolution are carried out as described below to update the feature quantities of the respective nodes.

In the first convolution, feature quantities of the nodes B and C connected to the node A are each multiplied by a predetermined weight and are then added to an initial feature quantity of the node A. For the node C, a feature quantity of the node D is multiplied by a predetermined weight and is then added to an initial feature quantity of the node C. Note that, in a case of an effective graph, the weight is adjusted according to a direction of the link.

In the second convolution, similarly to the first convolution, a feature quantity of a node linked to each node is multiplied by a predetermined weight, and is then added to a feature quantity of the each node. Here, the feature quantity of the node C reflects the feature quantity of the node D by the first convolution. Therefore, by the second convolution, not only the feature quantity of the node C but also the feature quantity of the node D are reflected in the node A.

By repeating the above-described process by a number of times corresponding to the hierarchy of nodes, feature quantities of nodes which are directly or indirectly connected to each other by links are mutually reflected. In graph-based relationship learning, a weight value used for the above-described weighting is optimized based on a known relationship between nodes. By using the learned graph, it is possible to predict an inter-node relation and predict a link destination node, as described below.

### (Inter-Node Relation Prediction)

By carrying out the learning described above, it is possible to predict an inter-node relation which is not explicitly indicated in the original graph. In a case of carrying out inter-node relation prediction, a user may specify two nodes and make a request for returning a relation between those nodes. For example, in a case where a request of inquiring about a relation between a node of “person A” and a node of “person B” is input from a user, it is possible to predict, by inter-node relation prediction, that a relation (i.e., a link) that connects these nodes is a “relationship of trust”. In the inter-node relation prediction, it is possible to calculate a probability (likelihood) of a prediction result. The same applies to node prediction described below.

### (Node Prediction)

By carrying out the above-described learning, it is also possible to predict a node that is connected to a certain node by a predetermined link. In a case of carrying out node prediction, a user may specify a single node and a link starting from that single node, and make a request for returning a link destination node. For example, it is assumed that a request for inquiring about a node connected to a node of “person A” by a link of “personality” is input from a user. In this case, for example, it is possible to predict, by node prediction, whether a node connected to the node of “person A” by the link of “personality” is “having strong sense of responsibility” or “curious”.

### Second Example Embodiment

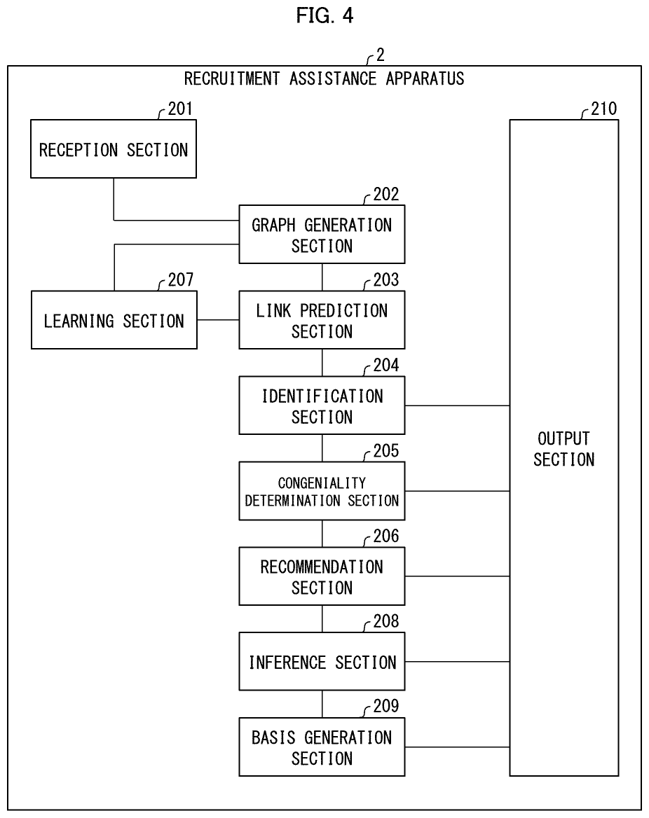

The following description will discuss a configuration of a recruitment assistance apparatus 2 in accordance with a second example embodiment of the present invention, with reference to FIG. 4. FIG. 4 is a block diagram illustrating the configuration of the recruitment assistance apparatus 2 in accordance with the present example embodiment.

As illustrated in FIG. 4, the recruitment assistance apparatus 2 includes a reception section 201, a graph generation section 202, a link prediction section 203, an identification section 204, a congeniality determination section 205, a recommendation section 206, a learning section 207, an inference section 208, a basis generation section 209, and an output section 210. In addition to these constituent elements, the recruitment assistance apparatus 2 may include an input apparatus for receiving an input operation by a user, an output apparatus for outputting data output by the recruitment assistance apparatus 2, a communication apparatus for enabling the recruitment assistance apparatus 2 to communicate with another apparatus, and the like. An output mode of the output apparatus may be arbitrarily set, and may be, for example, display output or audio output.

The reception section 201 receives a request pertaining to a place of assignment of a subject staff. Here, the request includes information pertaining to a subject staff for whom a user wants to decide a place of assignment. For example, the request includes, but not limited to, a name (or personal ID), an age, a personality, a desired type of work or desired place of assignment, a skill, and the like of a subject staff. For example, the request may be configured to include a current type of work and a current affiliation of the subject staff. The request may include the various kinds of elements which have been exemplified in the first example embodiment.

The graph generation section 202 refers to the request received by the reception section 201, and generates, based on information which is indicated by the request and which pertains to a subject staff for whom a user wants to decide a place of assignment, a subject staff graph representing that subject staff in the form of graph. Specifically, the graph generation section 202 generates a subject staff graph including (i) a plurality of nodes each pertaining to a skill or work experience of the subject staff and (ii) links each indicating a relationship between nodes. According to the configuration, it is possible to infer a candidate place of assignment by the inference section 208, which will be described later, while taking into consideration not only a skill and work experience of the subject staff but also a relationship between those. A specific process carried out by the graph generation section 202 will be described later.

The link prediction section 203 predicts, by link prediction using the subject staff graph which has been generated by the graph generation section 202 and which includes a plurality of nodes pertaining to the subject staff and the acceptance place graph, a staff node which links to a node included in the subject staff graph from among staff nodes which are included in the acceptance place graph and which indicate respective staffs belonging to the acceptance place, the link prediction being carried out for predicting a relationship between nodes which are not connected to each other by a link in the subject staff graph and the acceptance place graph.

Here, the acceptance place graph is, for example, a graph that includes (i) a plurality of nodes each pertaining to an acceptance place which is likely to accept the subject staff, a skill of each of the plurality of persons, or work experience of each of the plurality of persons and (ii) links each indicating a relationship between nodes. In other words, the acceptance place graph is a graph in which one or more persons are represented by (i) nodes indicating affiliations, skills, and work experience of the one or more persons and (ii) edges each indicating a relationship between the nodes. The acceptance place graph is a learned model and is a learned graph which has learned nodes and relationships between the nodes. The acceptance place graph can also be called a knowledge graph. A graph corresponding to a single person may be referred to as an acceptance place graph, or a graph corresponding to a plurality of persons may be referred to as an acceptance place graph.

According to the configuration, a staff node which links to a node included in the subject staff graph is predicted from among staff nodes in the acceptance place graph, and a candidate place of assignment is inferred based on the predicted staff node. How the subject staff is related to which staff at the acceptance place is useful information for a personnel matter of the subject staff. Therefore, according to the configuration, personnel assistance is realized while taking into consideration a staff who is related to the subject staff at the acceptance place.

The identification section 204 identifies, from among staffs included in the acceptance place graph, a congenial staff who is congenial to a particular staff.

Here, the link prediction section 203 described above may be configured to predict, by the link prediction, a similar staff who is similar to the subject staff from among the staffs belonging to the acceptance place. In this configuration, for example, the identification section 204 identifies, from among the staffs belonging to the acceptance place, a congenial staff who is indicated, by nodes and links included in the acceptance place graph, to be congenial to the similar staff.

According to the configuration, a staff node which indicates a similar staff similar to the subject staff is predicted, and a congenial staff who is indicated, by the nodes and the links included in the acceptance place graph, to be congenial to the similar staff is identified. The congenial staff who is congenial to the similar staff is more likely to be congenial also to the subject staff.

That is, according to the configuration, it is possible to identify a congenial staff who is more likely to be congenial to the subject staff from among the staffs belonging to the acceptance place. Therefore, according to the configuration, it is possible to provide a determination basis useful for determining congeniality between the subject staff and the acceptance place.

Alternatively, the identification section 204 may identify, from among the staffs included in the acceptance place graph, a staff who is uncongenial to a particular staff.

According to the configuration, a staff node which indicates a similar staff similar to the subject staff is predicted, and a staff who is uncongenial to the similar staff is identified by the nodes and the links included in the acceptance place graph. The staff who is uncongenial to the similar staff is more likely to be uncongenial also to the subject staff.

That is, according to the configuration, it is possible to identify a staff who is more likely to be uncongenial to the subject staff from among the staffs belonging to the acceptance place. Therefore, according to the configuration, it is possible to provide a determination basis useful for determining congeniality between the subject staff and the acceptance place.

The congeniality determination section 205 determines congeniality between the subject staff and the acceptance place based on a degree of similarity that indicates a degree to which the congenial staff identified by the identification section 204 is similar to each of the staffs belonging to the acceptance place.

An acceptance place to which staffs similar to the congenial staff belong is more likely to be congenial to the subject staff. In view of this, according to the configuration, congeniality between the subject staff and the acceptance place is determined based on a degree of similarity that indicates a degree to which the congenial staff is similar to each of the staffs belonging to the acceptance place. Thus, it is possible to precisely determine congeniality between the subject staff and the acceptance place.

Alternatively, the congeniality determination section 205 may determine congeniality between the subject staff and the acceptance place based on a degree of similarity that indicates a degree to which the uncongenial staff identified by the identification section 204 is similar to each of the staffs belonging to the acceptance place.

An acceptance place to which staffs similar to the uncongenial staff belong is more likely to be uncongenial to the subject staff. In view of this, according to the configuration, congeniality between the subject staff and the acceptance place is determined based on a degree of similarity that indicates a degree to which the uncongenial staff is similar to each of the staffs belonging to the acceptance place. Thus, it is possible to precisely determine congeniality between the subject staff and the acceptance place.

The congeniality determination section 205 may be configured to identify, from among a plurality of departments included in the acceptance place, a department to which the congenial staff identified by the identification section 204 belongs, and determine congeniality between the department and the subject staff based on a degree of similarity that indicates a degree to which the congenial staff is similar to each of staffs belonging to the department.

A department to which the congenial staff belongs is more likely to be congenial to the subject staff and, if a staff similar to the congenial staff belongs to that department, such a department is more likely to be further congenial to the subject staff. In view of this, according to the configuration, a department to which the congenial staff belongs is identified, and congeniality between the department and the subject staff is determined based on a degree of similarity indicating a degree to which the congenial staff is similar to each of staffs belonging to the department. Thus, it is possible to precisely determine congeniality between the subject staff and the department at the acceptance place.

Alternatively, the congeniality determination section 205 may be configured to identify, from among a plurality of departments included in the acceptance place, a department to which the uncongenial staff identified by the identification section 204 belongs, and determine congeniality between the department and the subject staff based on a degree of similarity that indicates a degree to which the uncongenial staff is similar to each of staffs belonging to the department.

A department to which the uncongenial staff belongs is more likely to be uncongenial to the subject staff and, if a staff similar to the uncongenial staff belongs to that department, such a department is more likely to be further uncongenial to the subject staff. In view of this, according to the configuration, a department to which the uncongenial staff belongs is identified, and congeniality between the department and the subject staff is determined based on a degree of similarity indicating a degree to which the uncongenial staff is similar to each of staffs belonging to the department. Thus, it is possible to precisely determine congeniality between the subject staff and the department at the acceptance place.

The recommendation section 206 refers to a result of a process carried out by at least one selected from the group consisting of the link prediction section 203, the identification section 204, and the congeniality determination section 205, and decides a department to be recommended as an acceptance place for each of a plurality of subject staffs.

Here, the congeniality determination section 205 described above may be configured to determine congeniality between each of the plurality of subject staffs and each of the plurality of departments. In this configuration, for example, the recommendation section 206 decides a department to be recommended as an acceptance place for each of the plurality of subject staffs based on a result of determination of congeniality by the congeniality determination section 205.

According to the configuration, congeniality between each of the plurality of subject staffs and each of the plurality of departments is determined, and a department to be recommended as an acceptance place is decided for each of the plurality of subject staffs based on the determination result. Thus, it is possible to recommend a department at the acceptance place while taking into consideration congeniality between each department and each subject staff.

The process carried out by the recommendation section 206 is not limited to the above example. For example, the recommendation section 206 may be configured to recommend, as an acceptance place of the subject staff, an affiliation of the congenial staff identified by the identification section 204.

The learning section 207 learns, based on various kinds of information pertaining to a plurality of persons, who are existing employees, a relationship between nodes included in an acceptance place graph, and generates a learned acceptance place graph. Unless otherwise specified, the acceptance place graph refers to a graph which has been subjected to learning by the learning section 207. The learned acceptance place graph may be read into the recruitment assistance apparatus 2. In such a case, the learning section 207 may be omitted.

The inference section 208 is configured to infer a candidate place of assignment that is of the subject staff and that conforms to a subject staff request based on the learned model and the request which pertains to a place of assignment of the subject staff and which has been received by the reception section 201. Here, the learned model is a learned model which has learned a relation between (i) at least one selected from the group consisting of a skill and work experience of each of a plurality of persons and (ii) an affiliation of each of the plurality of persons.

In the present example embodiment, for example, the learned model is a graph that includes (i) a plurality of nodes each pertaining to an acceptance place which is likely to accept the subject staff, a skill of each of the plurality of persons, or work experience of each of the plurality of persons and (ii) links each indicating a relationship between nodes. That is, the learned model is, for example, the acceptance place graph described above.

According to the configuration, it is possible to infer a candidate place of assignment that conforms to the request received by the reception section 201 and that is of the subject staff while taking into consideration various kinds of information pertaining to the acceptance place. Therefore, according to the configuration, it is possible to bring about an example advantage of carrying out personnel assistance for a subject staff while taking into consideration various kinds of information pertaining to an acceptance place.

The inference section 208 may infer a candidate place of assignment that conforms to the request received by the reception section 201 and that is of the subject staff based on the node predicted by the link prediction section 203 through the above-described process. The inference section 208 may infer a place of assignment that is of the subject staff and that conforms to the request with reference to a determination result by the recommendation section 206.

The basis generation section 209 generates basis information indicating a basis of inference carried out by the inference section 208. Various techniques can be applied as a method of generating basis information. The method for generating basis information will be described later.

As described above, the output section 210 outputs various kinds of information generated by the recruitment assistance apparatus 2, such as information indicating a candidate place of assignment inferred by the inference section 208. An output destination of the information may be arbitrarily set. For example, in a case where the recruitment assistance apparatus 2 includes an output apparatus as described above, the information may be output to the output apparatus. Alternatively, for example, the information may be output to an output apparatus provided outside the recruitment assistance apparatus 2.

### (Method of Generating Subject Staff Graph)

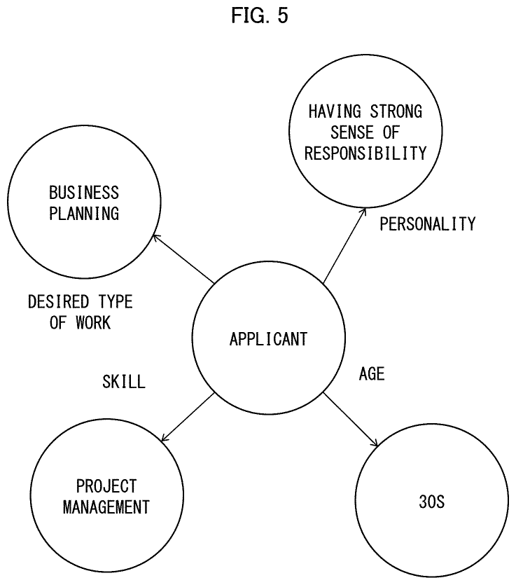

FIG. 5 is a schematic diagram illustrating an example of a method for generating a subject staff graph by the graph generation section 202. The graph generation section 202 first refers to a request received by the reception section 201 and identifies information which is indicated by the request and which pertains to a subject staff (applicant) for whom a user wants to decide a place of assignment.

FIG. 5 illustrates a subject staff graph which is generated by the graph generation section 202 in a case where the request includes the following pieces of information:
Personality: strong sense of responsibility;
Age: 30s;
Skill: project management; and
Desired type of work: business planning.
   Types of nodes included in the subject staff graph generated by the graph generation section 202 are not limited to those illustrated in FIG. 5, and the foregoing various kinds of nodes can be included.

### Process Example 1 Related to Identification of Similar Staff, Identification of Congenial Staff, and Determination of Congeniality Between Department and Subject Staff

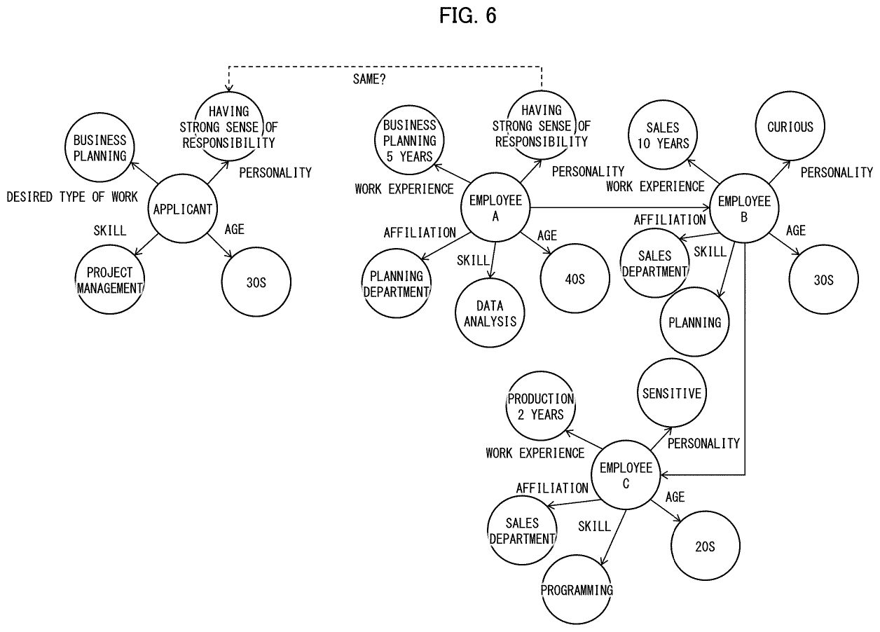

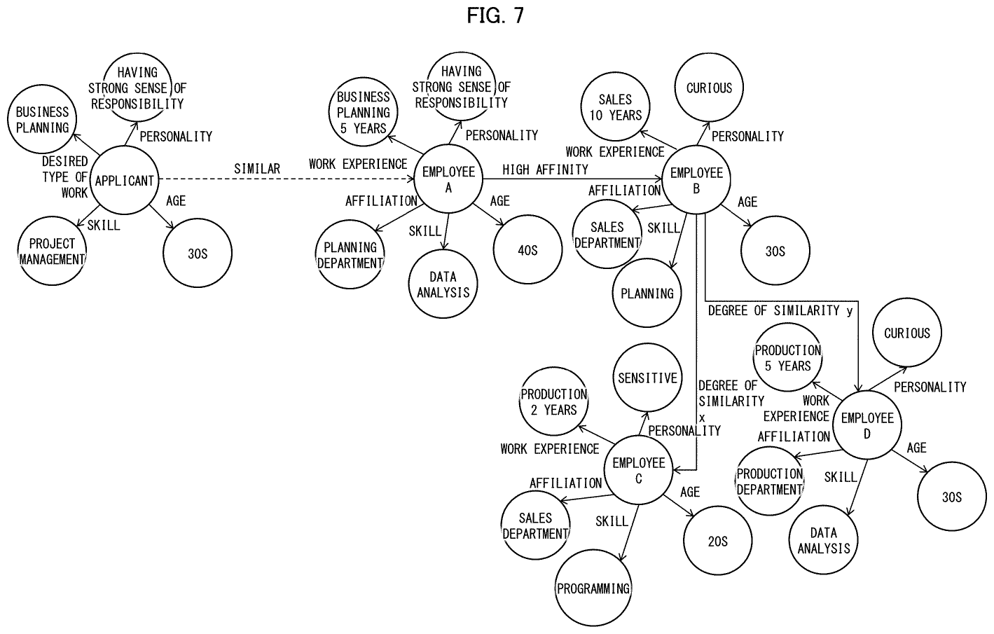

FIG. 6 and FIG. 7 are diagrams each illustrating a first process example related to a method for identifying a similar staff by the link prediction section 203, a method for identifying a congenial staff by the identification section 204, and a congeniality determination method by the congeniality determination section 205.

FIG. 6 shows an acceptance place graph in which existing employees A through C are represented by (i) nodes each indicating a personality, an age, a skill, an affiliation, or work experience of the existing employee, and (ii) links each representing a relationship between the nodes. For example, a node of “existing employee A” and a node of “having strong sense of responsibility” are connected to each other by an edge indicating “personality”. Thus, it is expressed that the existing employee A has a personality of having a strong sense of responsibility.

The acceptance place graph illustrated in FIG. 6 includes nodes of a plurality of existing employees, i.e., the existing employees A through C. Note, however, that a graph composed only of nodes pertaining to a single existing employee may be referred to as an acceptance place graph. In this case, the link prediction section 203 identifies a similar staff using a plurality of acceptance place graphs respectively corresponding to a number of existing employees.

Such acceptance place graphs can be each generated from a personality, an age, a skill, an affiliation, and work experience of each existing employee. By learning a relation between (i) a personality, an age, a skill, and work experience and (ii) an affiliation indicated in the acceptance place graph, it is possible to infer an affiliation suitable for a subject staff based on a personality, an age, a skill, a desired type of work, and the like of the subject staff.

FIG. 6 also illustrates a subject staff graph in which a subject staff (applicant) is represented by (i) nodes each indicating a personality, an age, a skill, or a desired type of work of the subject staff and (ii) edges (links) each representing a relationship between the nodes. More specifically, the subject staff graph illustrated in FIG. 6 includes, as with FIG. 5, (i) a node and a link indicating that the subject staff has a personality of “having strong sense of responsibility”, (ii) a node and a link indicating that the subject staff has an age of “30s”, (iii) a node and a link indicating that the subject staff has a skill of “project management”, and (iv) a node and a link indicating that the subject staff has a desired type of work which is “business planning”. As described above, the subject staff graph is generated by the graph generation section 202.

The link prediction section 203 carries out link prediction for predicting, by using the subject staff graph thus generated and the acceptance place graph, a relationship between nodes which are not connected to each other by a link in the subject staff graph and the acceptance place graph. The link prediction section 203 carries out the link prediction, and thereby predicts, for example, a staff node which links to a node included in the subject staff graph from among staff nodes which are included in the acceptance place graph and which indicate staffs belonging to the acceptance place.

For example, as indicated by the broken line in FIG. 6, a node of “having strong sense of responsibility” in the subject staff graph is not connected by a link to a node of “having strong sense of responsibility” of the existing employee A. The link prediction section 203 can predict, by carrying out link prediction, a probability that a relationship between these nodes is the “same”. Then, based on the predicted probability, the link prediction section 203 can identify a node of an existing employee graph that links to a node included in the subject staff graph. For example, the link prediction section 203 may identify, as a node that links to a node of the subject staff graph, a node of the existing employee graph for which the predicted probability value is equal to or more than a threshold.

The link prediction section 203 can predict, from among nodes included in an existing employee graph that includes a node conforming to a condition set in advance or a condition set by a user, a node that links to a node included in the subject staff graph.

For example, the link prediction section 203 can predict, from among nodes included in an existing employee graph including a node conforming to a predetermined personality or skill, a node that links to a node included in the subject staff graph.

The link prediction section 203 can identify an existing employee having a predetermined relationship with the subject staff by using the subject staff graph and the acceptance place graph. For example, it is possible to identify an existing employee similar to the subject staff. In addition, it is also possible to identify an existing employee who is not similar to the subject staff, an existing employee who belongs to the same classification as the subject staff, an existing employee who has a personality common to the subject staff, and the like.

The identification can be realized by link prediction for predicting a relationship between nodes which are not connected to each other by a link in the subject staff graph and the acceptance place graph. FIG. 7 is a diagram for illustrating the link prediction. FIG. 7 shows an acceptance place graph including a subject staff (applicant) graph and graphs of existing employees A through C, as with FIG. 6. As indicated by the broken line in FIG. 7, a node of “applicant” in the subject staff graph is not connected by a link to a node of “existing employee A” in the acceptance place graph.

The link prediction section 203 can predict, by carrying out link prediction, a probability that a relationship between these nodes is “similar”. The link prediction section 203 can predict, in a similar manner, a probability that a relationship between the node of “applicant” and a node of the existing employee B or C included in the acceptance place graph is “similar”. Then, the link prediction section 203 can identify a similar staff based on the predicted probability. For example, the link prediction section 203 may identify, as a similar staff, an existing employee for which a predicted probability value is equal to or more than a threshold. In the example illustrated in FIG. 7, the link prediction section 203 identifies the existing employee A as a similar staff similar to the applicant.

The link prediction section 203 can identify, as an existing employee having a predetermined relationship with the subject staff, an existing employee who conforms to a condition set in advance or a condition set by a user. For example, it is also possible to identify, as a similar staff, an existing employee whose personalities are at least partially common to the subject staff, and to identify, as a similar staff, an existing employee whose skills are at least partially common to the subject staff.

The identification section 204 refers to a graph of the similar staff identified as described above, and identifies, from among the staffs belonging to the acceptance place, a congenial staff who is indicated, by nodes and links included in the acceptance place graph, to be congenial to the similar staff.

In the example illustrated in FIG. 7, the identification section 204 identifies that the existing employee A, who is a similar staff, has high affinity to the existing employee B. In this case, the identification section 204 identifies the existing employee B as a congenial staff. Here, a process of calculating a degree of affinity by the identification section 204 can be carried out, for example, with reference to action data of each person. For example, in a case where a degree of similarity between (i) a history of position information of the existing employee A and (ii) a history of position information of the existing employee B is equal to or more than a predetermined value, it may be determined that the existing employee A and the existing employee B have a high degree of affinity to each other. Alternatively, in a case where pieces of action data of the existing employee A and the existing employee B indicate that both are main communication partners of each other, it may be determined that the existing employee A and the existing employee B have a high degree of affinity to each other.

The congeniality determination section 205 determines congeniality between the subject staff and the acceptance place based on a degree of similarity that indicates a degree to which the congenial staff is similar to each of staffs belonging to the acceptance place.

The link prediction section 203 can predict a probability (degree of similarity) that a relationship between (i) a node of a certain existing employee included in the acceptance place graph and (ii) a node of another existing employee is “similar”. In the example illustrated in FIG. 7, the congeniality determination section 205 calculates that a degree of similarity between the existing employee B, who is a congenial staff, and the existing employee C is x, and calculates that a degree of similarity between the existing employee B, who is a congenial staff, and the existing employee D is y.

The congeniality determination section 205 determines congeniality between the subject staff and the acceptance place based on the degree of similarity predicted by the link prediction section 203. For example, it is possible that: an affiliation to which an existing employee whose degree of similarity to the existing employee B, who is a congenial staff, is equal to or more than a threshold belongs is determined to be a congenial acceptance place; and an affiliation to which an existing employee whose degree of similarity to the existing employee B, who is a congenial staff, is less than the threshold belongs is determined to be an uncongenial acceptance place.

An acceptance place to which staffs similar to the congenial staff belong is more likely to be congenial to the subject staff. In view of this, according to the configuration, congeniality between the subject staff and the acceptance place is determined based on a degree of similarity that indicates a degree to which the congenial staff is similar to each of the staffs belonging to the acceptance place. Thus, it is possible to precisely determine congeniality between the subject staff and the acceptance place.

### Process Flow in Process Example 1

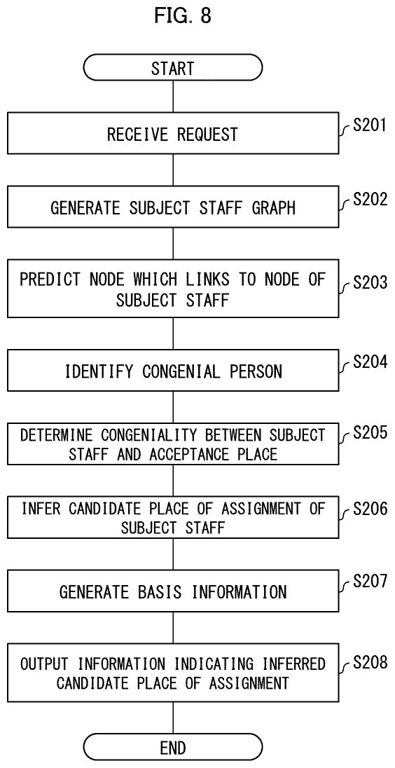

The following description will discuss a flow of a process (recruitment assistance method) carried out by the recruitment assistance apparatus 2, with reference to FIG. 8. FIG. 8 is a flowchart illustrating the flow of the process (process example 1) carried out by the recruitment assistance apparatus 2.

In S201, the reception section 201 receives a request pertaining to a place of assignment of a subject staff. In S201, for example, a request including an age, a personality, a desired type of work, a skill, and the like of the subject staff is received. That is, the request includes, as described above, at least one selected from the group consisting of, for example, an age, a personality, a desired type of work, a skill, and the like of the subject staff.

In S202, the graph generation section 202 refers to the request received in S201 and generates, based on the information which is indicated by the request and which pertains to the subject staff, a subject staff graph representing the subject staff in the form of graph. For example, in S202, a subject staff graph may be generated which includes (i) nodes each indicating an age, a personality, a desired type of work, or a skill of the subject staff and (ii) links each indicating a relationship between nodes.

In S203, the link prediction section 203 predicts a node that links to a node included in the subject staff graph generated in S202. As described above, the node is predicted by link prediction using the learned acceptance place graph and the subject staff graph.

In S203, the link prediction section 203 may predict, for example, a node connected to a node of “subject staff” by a link of “personality” or “skill”. Alternatively, a node connected to a node indicating a personality or a skill may be predicted. For example, a node connected to a node indicating a skill by a link of “qualification” may be predicted. Thus, it is also possible to predict a node connected to a more detailed node pertaining to a personality or a skill of the subject staff.

In S204, the identification section 204 identifies, from among the staffs belonging to the acceptance place, a congenial staff who is indicated, by nodes and links included in the acceptance place graph, to be congenial to the similar staff.

In S205, the congeniality determination section 205 determines congeniality between the subject staff and the acceptance place based on a degree of similarity that indicates a degree to which the congenial staff identified in S204 is similar to each of the staffs belonging to the acceptance place.

In S206, the inference section 208 infers a candidate place of assignment that is of the subject staff and that conforms to the request based on the learned model and the request which pertains to a place of assignment of the subject staff and which has been received in S201.

In this S206, the inference section 208 may infer, with reference to a determination result by the congeniality determination section 205 in S205, an acceptance place for which a degree of congeniality is equal to or more than a predetermined level as a candidate place of assignment that conforms to the request.

In S207, the basis generation section 209 generates basis information indicating a basis of inference carried out by the inference section 208. Specifically, basis information may be generated which includes a degree of similarity between (i) an attribute of the subject staff and (ii) an attribute of a person who belongs to the candidate place of assignment inferred by the inference section 208 in S206.

In S208, the output section 210 outputs the candidate place of assignment inferred in S206. The output section 210 may be configured to output, together with the candidate place of assignment inferred in S206, the basis information generated in S207. Thus, the process of FIG. 8 ends.

The process of S205 may be omitted, and an affiliation of the congenial person identified in S204 may be inferred as a candidate place of assignment of the subject staff. The link prediction section 203 can directly predict a candidate place of assignment of the subject staff by link prediction using the subject staff graph and the acceptance place graph. This is because, even while omitting identification of a similar staff or a congenial staff, a relation between a staff and an acceptance place congenial to the staff is learned when training an acceptance place graph, while taking into consideration similarity and congeniality between staffs. In this case, S204 and S205 are omitted.

Process Example 2 Related to Identification of Similar Staff, Identification of Congenial Staff, Determination of Congeniality Between Department and Subject Staff, and Decision of Department to be Recommended

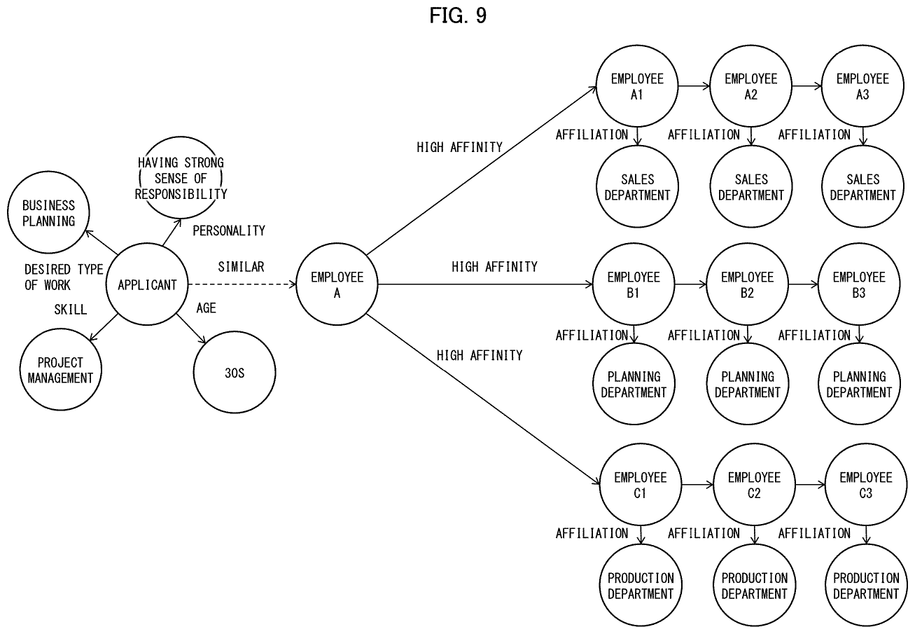

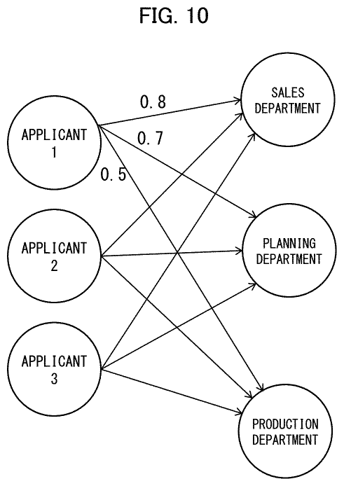

FIG. 9 is a diagram illustrating a second process example related to a method for identifying a similar staff by the link prediction section 203, a method for identifying a congenial staff by the identification section 204, and a congeniality determination method by the congeniality determination section 205.

FIG. 9 shows an acceptance place graph including (i) nodes indicating affiliations of existing employees A1 through A3, existing employees B1 through B3, and existing employees C1 through C3, and (ii) links each indicating a relationship between nodes. The acceptance place graph illustrated in FIG. 9 also includes a node indicating the existing employee A. In the example illustrated in FIG. 9, it is indicated that the existing employees A1 through A3 belong to a sales department, the existing employees B1 through B3 belong to a planning department, and the existing employees C1 through C3 belong to a production department.

Note that the existing employee A, the existing employees A1 through A3, the existing employees B1 through B3, and the existing employees C1 through C3 illustrated in FIG. 9 also have links with other nodes, but such links are not illustrated in FIG. 9.

The acceptance place graph illustrated in FIG. 9 includes nodes of a plurality of existing employees, i.e., the existing employees A1 through C3. Note, however, that a graph composed only of nodes pertaining to a single existing employee may be referred to as an acceptance place graph. In this case, the link prediction section 203 identifies a similar staff using a plurality of acceptance place graphs respectively corresponding to a plurality of existing employees.

FIG. 9 also illustrates a subject staff graph in which a subject staff (applicant) is represented by (i) nodes each indicating a personality, an age, a skill, or a desired type of work of the subject staff and (ii) edges (links) each representing a relationship between the nodes, as with FIGS. 5 and 7.

In the example illustrated in FIG. 9 also, the link prediction section 203 can identify an existing employee having a predetermined relationship with the subject staff by using the subject staff graph and the acceptance place graph. The identification can be realized by link prediction for predicting a relationship between nodes which are not connected to each other by a link in the subject staff graph and the acceptance place graph. For example, as indicated by the broken line in FIG. 9, a node of “applicant” in the subject staff graph is not connected by a link to a node of “existing employee A” in the acceptance place graph.

The link prediction section 203 can predict, by carrying out link prediction, a probability that a relationship between these nodes is “similar”. The link prediction section 203 can predict, in a similar manner, a probability that a relationship between the node of “applicant” and a node of each of the existing employees A1 through A3, B1 through B3, and C1 through C3 included in the acceptance place graph is “similar”. Then, the link prediction section 203 can identify a similar staff based on the predicted probability. For example, the link prediction section 203 may identify, as a similar staff, an existing employee for which a predicted probability value is equal to or more than a threshold.

In the example illustrated in FIG. 9 also, the link prediction section 203 can identify, as an existing employee having a predetermined relationship with the subject staff, an existing employee who conforms to a condition set in advance or a condition set by a user. For example, it is also possible to identify, as a similar staff, an existing employee whose personalities are at least partially common to the subject staff, and to identify, as a similar staff, an existing employee whose skills are at least partially common to the subject staff.

The identification section 204 refers to the graph of the similar staff identified as described above, and identifies, from among the staffs belonging to the acceptance place, a congenial staff who is indicated, by nodes and links included in the acceptance place graph, to be congenial to the similar staff.

In the example illustrated in FIG. 9, the identification section 204 identifies that the existing employee A, who is a similar staff, has high affinity to the existing employees A1 through A3. In this case, the identification section 204 identifies the existing employees A1 through A3 as congenial staffs. Here, a process of calculating a degree of affinity by the identification section 204 can be carried out, for example, with reference to action data of each person, as described in the process example 1.

The congeniality determination section 205 identifies, from among a plurality of departments included in the acceptance place, a department to which the congenial staff identified by the identification section 204 belongs, and determines congeniality between the department and the subject staff based on a degree of similarity that indicates a degree to which the congenial staff is similar to each of staffs belonging to the department.

In the example illustrated in FIG. 9, the link prediction section 203 calculates a degree of similarity between (i) the existing employee A1, who is a congenial staff, and (ii) existing employees A2 and A3 who belong to the same affiliation (sales department). The congeniality determination section 205 determines congeniality between the department (sales department) and the subject staff according to the degree of similarity between the existing employees A1 and A2 and the degree of similarity between the existing employees A1 and A3.

For example, in a case where both of the degree of similarity between the existing employees A1 and A2 and the degree of similarity between the existing employees A1 and A3 are equal to or more than a predetermined threshold, it may be determined that congeniality between the sales department and the subject staff is good. By carrying out a similar process also for the existing employees B1 through B3 and the existing employees C1 through C3, it is possible to determine congeniality between the planning department and the subject staff, and congeniality between the production department and the subject staff.

In the example illustrated in FIG. 9, only a single subject staff is illustrated. However, the link prediction section 203, the identification section 204, and the congeniality determination section 205 can determine congeniality between a plurality of subject staffs and a plurality of departments by processes similar to the process described above.

A department to which the congenial staff belongs is more likely to be congenial to the subject staff and, if a staff similar to the congenial staff belongs to that department, such a department is more likely to be further congenial to the subject staff. In view of this, according to the configuration, a department to which the congenial staff belongs is identified, and congeniality between the department and the subject staff is determined based on a degree of similarity indicating a degree to which the congenial staff is similar to each of staffs belonging to the department. Thus, it is possible to precisely determine congeniality between the subject staff and a department at the acceptance place.

The recommendation section 206 decides a department to be recommended as an acceptance place for each of the plurality of subject staffs based on a result of determination of congeniality by the congeniality determination section 205. FIG. 10 is a diagram for illustrating a process carried out by the recommendation section 206.

In the example illustrated in FIG. 10, it is inferred, by processes carried out with the link prediction section 203, the identification section 204, and the congeniality determination section 205, that: a degree of congeniality between an applicant 1 and the sales department is 0.8; a degree of congeniality between the applicant 1 and the planning department is 0.7; and a degree of congeniality between the applicant 1 and the production department is 0.5. Although not illustrated in FIG. 10, a degree of congeniality between another applicant and each department is also inferred.

Referring to such a congeniality inference result, the recommendation section 206 decides, for each of the applicants 1 through 3, a department to be recommended as an acceptance place for the applicant. For example, for the applicant 1, the sales department with the greatest degree of congeniality is decided as a recommended department.

The recommendation section 206 may decide a place of assignment that maximizes a total degree of affinity (degree of congeniality) while satisfying a constraint (such as the number of persons belonging to each department) specified by a user. At this time, an optimization solver such as a maximum satisfiability (MaxSAT) may be used.

According to the configuration, congeniality between each of the plurality of subject staffs and each of the plurality of departments is determined, and a department to be recommended as an acceptance place is decided for each of the plurality of subject staffs based on the determination result. Thus, it is possible to recommend a department at the acceptance place while taking into consideration congeniality between each department and each subject staff.

### Process Flow in Process Example 2

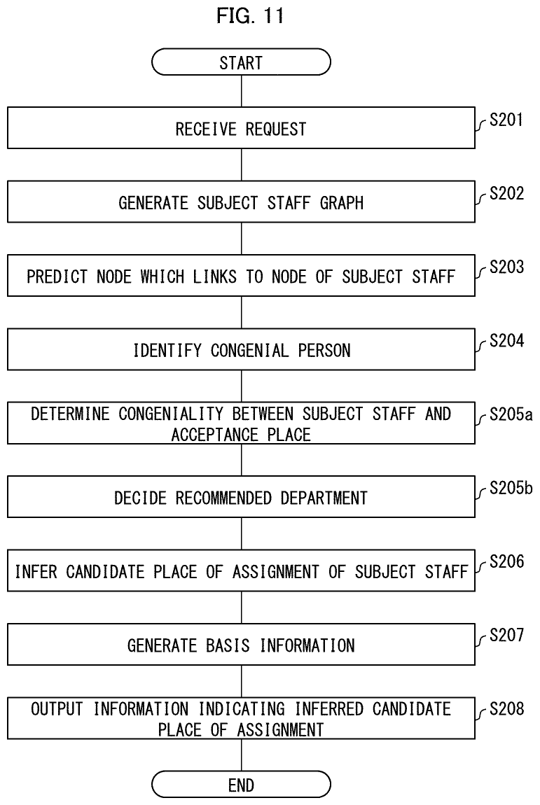

The following description will discuss a flow of a process (recruitment assistance method) carried out by the recruitment assistance apparatus 2, with reference to FIG. 11. FIG. 11 is a flowchart illustrating the flow of the process (process example 2) carried out by the recruitment assistance apparatus 2.

S201 through S204 are similar to S201 through S204 illustrated in FIG. 8, and therefore descriptions thereof are not repeated.

After S201, in S205a, the congeniality determination section 205 identifies, from among a plurality of departments included in the acceptance place, a department to which the congenial staff identified by the identification section 204 in S204 belongs, and determines congeniality between the department and the subject staff based on a degree of similarity that indicates a degree to which the congenial staff is similar to each of staffs belonging to the department.

After S205a, in S205b, the recommendation section 206 decides a department to be recommended as an acceptance place for each of the plurality of subject staffs based on a result of determination of congeniality by the congeniality determination section 205 in S205a.

After S209, in S206, the inference section 208 infers a place of assignment that is of the subject staff and that conforms to the subject staff request based on the learned model and the request which pertains to a place of assignment of the subject staff and which has been received in S201.

In this S206, for example, the inference section 208 may infer, as a candidate place of assignment that conforms to the request received by the reception section 201 and that is of the subject staff, a department to be recommended which has been decided by the recommendation section 206 in S205b.

In S207, the basis generation section 209 generates basis information indicating a basis of inference carried out by the inference section 208. Specifically, basis information may be generated which includes a degree of similarity between (i) an attribute of the subject staff and (ii) an attribute of a person who belongs to the candidate place of assignment inferred by the inference section 208 in S206.

In S208, the output section 210 outputs the candidate place of assignment inferred in S206. The output section 210 may be configured to output, together with the candidate place of assignment inferred in S206, the basis information generated in S207. Thus, the process of FIG. 11 ends.

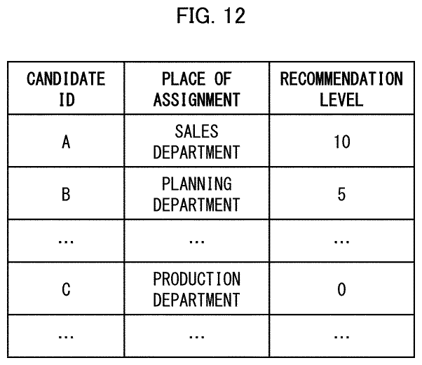

FIG. 12 is a diagram illustrating an example of an inference result output by the output section 210 in accordance with the present process example. As illustrated in FIG. 12, for example, the output section 210 presents, together with a candidate place of assignment that is an inference result by the inference section 208, a recommendation level calculated based on a determination result by the congeniality determination section 205.

### (Method of Generating Basis Information)

The following description will discuss a method for generating basis information by the basis generation section 209. As described above, various techniques can be applied as a method of generating basis information. The basis generation section 209 generates, for example, basis information that includes a degree of similarity between (i) an attribute of the subject staff and (ii) an attribute of a person who belongs to the candidate place of assignment inferred by the inference means. The generated basis information is output by the output section 210.

Here, the attribute of the subject staff may include, but not limited to, an age, a personality, a skill, and the like. For example, the attribute of the subject staff may be configured to include any of the elements of the nodes described in [Graph and learning] above.

The basis generation section 209 can generate basis information such as, for example, “a degree of similarity between (i) a personality of the subject staff and (ii) a personality of an existing employee A belonging to the sales department is 0.8”.

According to the configuration, basis information is generated which includes a degree of similarity between (i) an attribute of the subject staff and (ii) an attribute of a person who belongs to the inferred candidate place of assignment. Thus, a user can refer to a candidate place of assignment while taking into consideration a basis thereof. In particular, it is important to secure transparency in personnel matters, and therefore the feature of being capable of generating basis information brings about a great advantage.

The basis generation section 209 may generate basis information based on a result of link prediction by the link prediction section 203. In this case, the link prediction section 203 predicts, with use of an acceptance place graph including a node indicating an attribute possessed by the subject staff and the subject staff graph, a probability that a node indicating the attribute links to a node included in the subject staff graph. The basis generation section 209 generates basis information corresponding to the predicted probability.

The basis generation section 209 can generate basis information such as, for example, “a probability that a skill of the subject staff links to a skill of an existing employee A belonging to the sales department is 0.9”.

With the configuration as described above also, a user can refer to a candidate place of assignment while taking into consideration a basis thereof.

(Basis Generation with Respect to Link Prediction Result)

The basis generation section 209 can generate basis information also by analyzing a subject staff graph and an acceptance place graph. The following description will discuss a method of generating basis information by analyzing a subject staff graph and an acceptance place graph.

For example, the basis generation section 209 may mine one or more rules from the subject staff graph and the acceptance place graph using principal component analysis (PCA) reliability based on open-world assumption (OWA). The basis generation section 209 may generate basis information using one or more rules that have been mined. For example, a method described in the following literature can be applied to mining of a rule.
Luis Galarraga et. al, “Fast rule mining in ontological knowledge bases with AMIE+”, The VLDB Journal (2015) 24:707-730

For example, a rule to be processed by the basis generation section 209 is expressed by

$${B}_{1} ⋀ {B}_{2} ⋀ … ⋀ B \text{?} ⇒ r ( x , y )$$

$$\text{?} \text{indicates text missing or illegible when filed}$$

using Head r(x, y) and Body {B1, . . . , Bn}. This rule may also be expressed as

B⇒r(x,y)

using a vector representation. Here, Head r(x, y) is also called an atom.

As a condition of the mining process, the basis generation section 209 uses the following conditions to carry out the mining process:
Connected: all values (variables, entities) in a rule are shared between different atoms;
Closed: all variables in a rule appear two times or more; and
Not reflexive: a rule containing a reflective atom (such as r(x, x)) is not mined.

The basis generation section 209 may use a head coverage (hc) defined by

$$hc ( \vec{B} ⇒ r ( x , y ) ) := \frac{supp \vec{B} ⇒ r ( x , y )}{size ( r )}$$

and PCA reliability defined by

$$\frac{conf \text{?} ( \vec{B} ⇒ r ( x , y ) ) := supp \vec{B} ⇒ r ( x , y )}{\# ( x , y ) \text{?} , … , {z}_{m} , {y}^{′} : \vec{B} ⋀ r ( x , {y}^{′} )}$$

$$\text{?} \text{indicates text missing or illegible when filed}$$

to carry out the mining process. By using PCA reliability, it is possible to mine a rule with higher accuracy, as compared with a case of using standard reliability. Therefore, by using the above configuration, it is possible for the basis generation section 209 to generate highly reliable basis information.

For example, it is assumed that the basis generation section 209 has mined a rule that “element included in one person can be applied to another person” for two persons who satisfy a condition of “having common personality” or “having common skill”. In this case, if the link prediction section 203 has predicted, as an element included in the subject staff, an element included in a certain existing employee, the basis generation section 209 may generate, as a basis of the prediction, basis information indicating that the certain existing employee and the subject staff “have a common personality” or “have a common skill”.

By presenting basis information as described above, a user can refer to a candidate place of assignment while taking into consideration a basis thereof.

### Third Example Embodiment

The following will discuss in detail a third example embodiment of the present invention, with reference to the drawings. A configuration of a recruitment assistance apparatus in accordance with the present example embodiment is similar to the configuration of the recruitment assistance apparatus 2 in accordance with the second example embodiment. Note, however, that, in the recruitment assistance apparatus in accordance with the present example embodiment, processes carried out by the link prediction section 203 and the inference section 208 are different from those in the recruitment assistance apparatus 2 in accordance with the second example embodiment.

The link prediction section 203 in accordance with the present example embodiment identifies a staff or a department that is at an acceptance place which is likely to accept the subject staff and that has a predetermined relationship with the subject staff by link prediction using an acceptance place graph and a subject staff graph including a plurality of nodes pertaining to the subject staff, the acceptance place graph including (i) a plurality of nodes each pertaining to the acceptance place, a skill of each of the plurality of persons, or work experience of each of the plurality of persons and (ii) links each indicating a relationship between nodes, and the link prediction being carried out for predicting a relationship between nodes which are not connected to each other by a link in the subject staff graph and the acceptance place graph.

Then, the inference section 208 infers a candidate place of assignment that is of the subject staff and that conforms to the request based on the staff or department at the acceptance place that has been identified by the link prediction section 203.

According to the configuration, a staff or a department that is at the acceptance place and that has a predetermined relationship with the subject staff is identified, and a candidate place of assignment which is of the subject staff and which conforms to the request received by the reception section 201 is inferred based on the staff or the department. Information pertaining to a staff or a department having a predetermined relationship with the subject staff is information useful for a personnel matter of the subject staff. Therefore, according to the configuration, it is possible to precisely carry out personnel assistance for the subject staff.

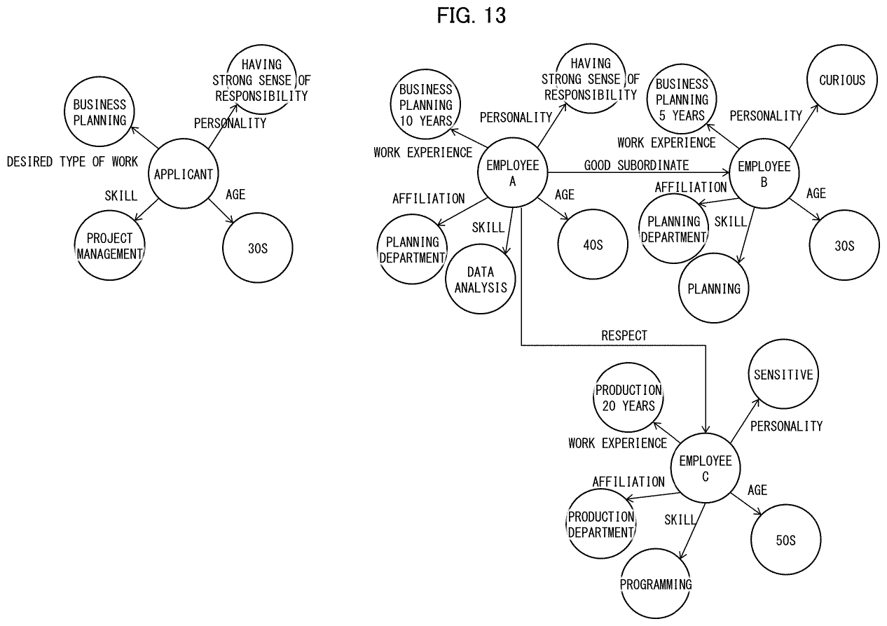

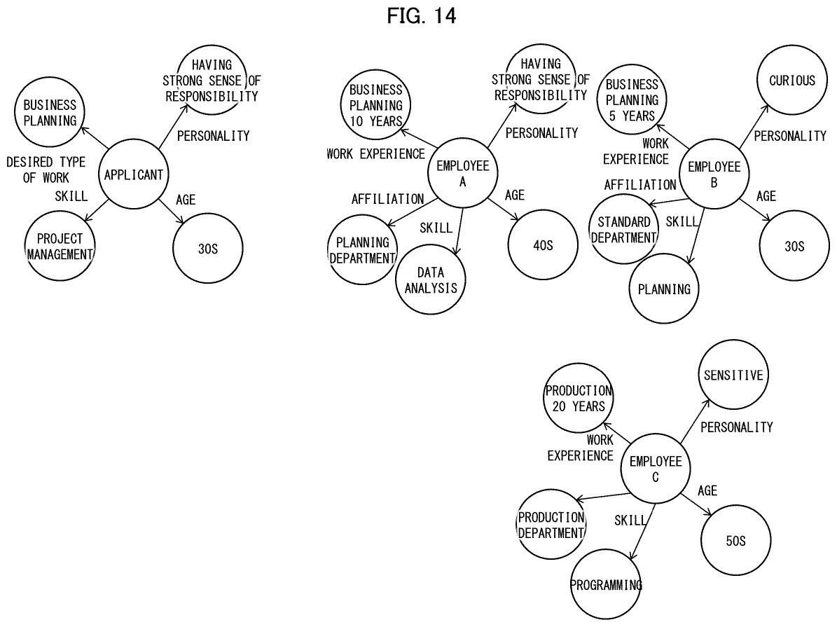

The following description will discuss processes carried out by the link prediction section 203 and the inference section 208 in accordance with the present example embodiment, with reference to FIG. 13 and FIG. 14.

### Process Example 1 Related to Inference of Relationship and Inference of Candidate Place of Assignment

FIG. 13 is a diagram for describing a process example 1 in which the link prediction section 203 and the inference section 208 in accordance with the present example embodiment infer a relationship between a subject staff and an existing employee and infer a candidate place of assignment based on the inferred relationship.

FIG. 13 shows an acceptance place graph in which existing employees A through C are represented by (i) nodes each indicating a personality, an age, a skill, an affiliation, or work experience of the existing employee, and (ii) edges (links) each representing a relationship between the nodes.

The acceptance place graph illustrated in FIG. 13 includes nodes of a plurality of existing employees, i.e., the existing employees A through C. Note, however, that a graph composed only of nodes pertaining to a single existing employee may be referred to as an acceptance place graph.

Such an acceptance place graph can be generated from a personality, an age, a skill, an affiliation, and work experience of each existing employee, as with the second example embodiment. By learning a relation between (i) a personality, an age, a skill, and work experience and (ii) an affiliation indicated in the acceptance place graph, it is possible to infer a relation between (i) a personality, an age, a skill, and a desired type of work of the subject staff and (ii) an affiliation of an existing employee.

Furthermore, in the present example embodiment, it is possible to infer a relationship between persons by learning also relations between nodes of existing employees included in the acceptance place graph. For example, in the example illustrated in FIG. 13, a node of the existing employee A is connected to a node of the existing employee B by a link indicating that “the existing employee B is a good subordinate for the existing employee A”, and the node of the existing employee A is connected to a node of the existing employee C by a link indicating that “the existing employee A respects the existing employee C”.

Learning of such a relationship between existing employees in the acceptance place graph can be carried out by, for example, learning with reference to nodes indicating an evaluation record, an interview record, action data, and the like of each existing employee. Note, however, that this example does not limit the present example embodiment.

FIG. 6 also illustrates a subject staff graph in which a subject staff (applicant) is represented by (i) nodes each indicating a personality, an age, a skill, or a desired type of work of the subject staff and (ii) edges (links) each representing a relationship between the nodes.

The link prediction section 203 carries out link prediction for predicting, by using the subject staff graph thus generated and the acceptance place graph, a relationship between nodes which are not connected to each other by a link in the subject staff graph and the acceptance place graph. Then, by carrying out the link prediction, the link prediction section 203 identifies, for example, a staff at the acceptance place who has a predetermined relationship with the subject staff.

For example, as illustrated in FIG. 13, a node of the subject staff (applicant) is not connected to a node of the existing employee A by a link. The link prediction section 203 can predict, by carrying out link prediction, a probability that a relationship between these nodes is a predetermined relationship. For example, the link prediction section 203 can predict a probability that a relationship between these nodes is that “the applicant is a good subordinate for the existing employee A” and a probability that the relationship between these nodes is that “the applicant respects the existing employee A”.

The link prediction section 203 may identify, as a node that links to the node of the subject staff with a certain relationship, a node of an existing employee for which a probability value predicted with respect to the certain relationship is equal to or more than a threshold.

The inference section 208 infers, based on the staff at the acceptance place who has been thus identified by the link prediction section 203, a candidate place of assignment that is of the subject staff and that conforms to the request received by the reception section 201. For example, the inference section 208 may infer, as a candidate place of assignment that is of the subject staff and that conforms to the request, an affiliation to which the existing employee belongs who has been predicted to have a good relationship with the subject staff (e.g., “the applicant is a good subordinate for the existing employee A” or “the applicant respects the existing employee A”).

The link prediction section 203 can predict, from among nodes included in an existing employee graph including a node that conforms to a condition set in advance or a condition set by a user, an existing employee who links to the node of the subject staff with a predetermined relationship.

The “predetermined relationship” is not limited to the above example. By using the subject staff graph and the acceptance place graph, the link prediction section 203 can identify an existing employee similar to the subject staff, and can also identify an existing employee who is not similar to the subject staff, an existing employee who belongs to the same classification as the subject staff, an existing employee who has a personality common to the subject staff, and the like.

### Process Example 1 Related to Inference of Relationship and Inference of Candidate Place of Assignment

FIG. 14 is a diagram for describing a process example 1 in which the link prediction section 203 and the inference section 208 in accordance with the present example embodiment infer a relationship between a subject staff and an existing employee and infer a candidate place of assignment based on the inferred relationship.

FIG. 14 shows an acceptance place graph in which existing employees A through C are represented by (i) nodes each indicating a personality, an age, a skill, an affiliation, or work experience of the existing employee, and (ii) edges (links) each representing a relationship between the nodes.

The acceptance place graph illustrated in FIG. 14 includes nodes of a plurality of existing employees, i.e., the existing employees A through C. Note, however, that a graph composed only of nodes pertaining to a single existing employee may be referred to as an acceptance place graph.

Such an acceptance place graph can be generated from a personality, an age, a skill, an affiliation, and work experience of each existing employee, as with the second example embodiment. By learning a relation between (i) a personality, an age, a skill, and work experience and (ii) an affiliation indicated in the acceptance place graph, it is possible to infer an affiliation suitable for a subject in accordance with a personality, an age, a skill, and a desired type of work of the subject staff.

Furthermore, in the present example embodiment, it is possible to infer a relation between a person and an affiliation by learning a relation between a node of an existing employee included in the acceptance place graph and an affiliation.

FIG. 14 also illustrates a subject staff graph in which a subject staff (applicant) is represented by (i) nodes each indicating a personality, an age, a skill, or a desired type of work of the subject staff and (ii) edges (links) each representing a relationship between the nodes.

The link prediction section 203 carries out link prediction for predicting, by using the subject staff graph thus generated and the acceptance place graph, a relationship between nodes which are not connected to each other by a link in the subject staff graph and the acceptance place graph. Then, by carrying out the link prediction, the link prediction section 203 identifies, for example, a department at the acceptance place that has a predetermined relationship with the subject staff.

For example, as illustrated in FIG. 14, a node of the subject staff (applicant) is not connected to nodes of “affiliation” in the respective existing employee graphs A through C by links. The link prediction section 203 can predict, by carrying out link prediction, a probability that a relationship between these nodes is a predetermined relationship. For example, the link prediction section 203 can predict a probability that a relationship between these nodes is good.

The link prediction section 203 may identify, as a node that links to the node of the subject staff with a certain relationship, a node of an existing employee for which a probability value predicted with respect to the certain relationship is equal to or more than a threshold.

The inference section 208 infers, based on the department at the acceptance place which has been thus identified by the link prediction section 203, a candidate place of assignment that is of the subject staff and that conforms to the request received by the reception section 201. For example, the inference section 208 may infer, as a candidate place of assignment that is of the subject staff and that conforms to the request, a department at an acceptance place which has been predicted to have a good relationship with the subject staff.

### Fourth Example Embodiment

The following description will discuss a recruitment assistance apparatus 4 in accordance with the fourth example embodiment of the present invention, with reference to the drawings. The recruitment assistance apparatus 4 carries out personnel assistance for a subject staff. As a personnel assistance method, there is a case of determining whether or not a subject staff has a business characteristic which a user demands. The recruitment assistance apparatus 4 carries out personnel assistance in such a case.

### Overview

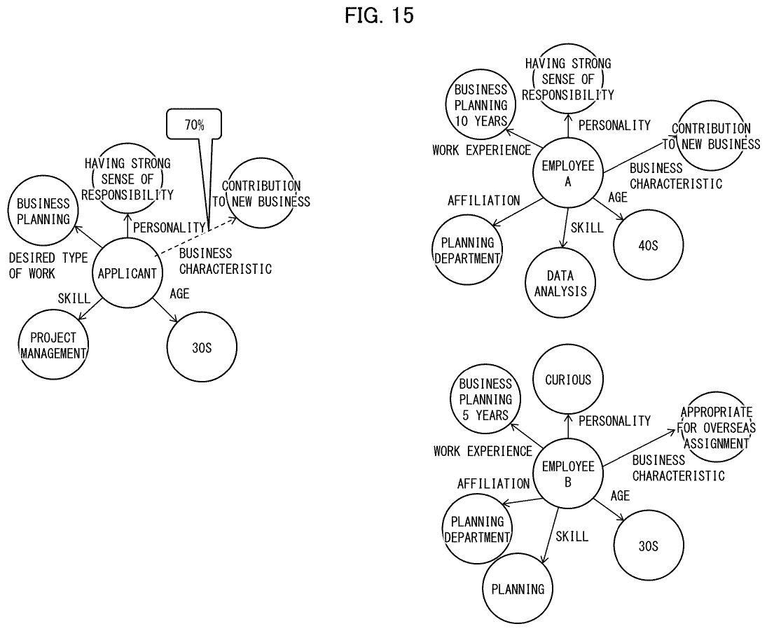

FIG. 15 is a diagram illustrating an overview of a recruitment assistance method in accordance with the present example embodiment. In the present example embodiment, as in the second example embodiment, link prediction is carried out using a subject staff graph and an acceptance place graph. The subject staff graph indicated in the upper left part of FIG. 15 includes nodes and links indicating that the subject staff has a personality of “having strong sense of responsibility”, and the like.

The acceptance place graph indicated in the upper right part of FIG. 15 includes nodes and links indicating that the existing employee A has a personality of “having strong sense of responsibility”, and business characteristics of the existing employee A include “contribution to new business”. Similarly, the acceptance place graph indicated in the lower right part of FIG. 14 includes nodes and links indicating that the existing employee B has a personality of “curious” and business characteristics of the existing employee B include “appropriate for overseas assignment”.

By training the acceptance place graph for various existing employees as described above, it is possible to carry out link prediction for predicting what person is likely to have what business characteristic. That is, in the recruitment assistance method in accordance with the present example embodiment, a subject staff graph is generated, and a probability that a subject staff indicated in the subject staff graph has a requested business identification is predicted by link prediction.

For example, in the example of FIG. 15, it is predicted that a probability that a node of “contribution to new business” is connected to the node of “applicant” by a link of “business characteristic” is 70% in the subject staff graph indicated in the upper left part. Therefore, it can be said that the applicant is a staff who seems to “contribute to new business”.

As such, according to the recruitment assistance method in accordance with the present example embodiment, it is possible to present, to a user, a probability that the subject staff has an intended business characteristic, and thus assist recruitment of a staff.

### (Apparatus Configuration)

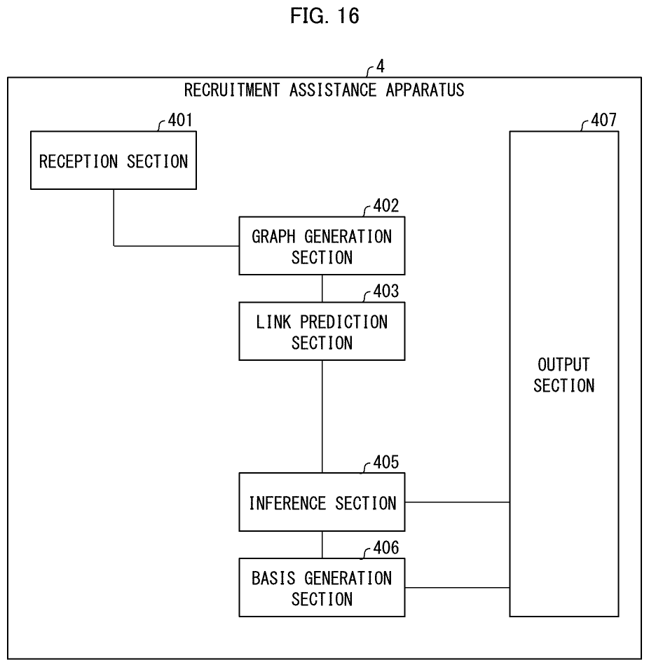

The following description will discuss a configuration of the recruitment assistance apparatus 4 in accordance with the fourth example embodiment of the present invention, with reference to FIG. 16. FIG. 16 is a block diagram illustrating the configuration of the recruitment assistance apparatus 4 in accordance with the present example embodiment.

As illustrated in FIG. 16, the recruitment assistance apparatus 4 includes a reception section 401, a graph generation section 402, a link prediction section 403, an inference section 405, a basis generation section 406, and an output section 407. As with the recruitment assistance apparatus 2 of the second example embodiment, the recruitment assistance apparatus 4 may include, in addition to these constituent elements, an input apparatus for receiving an input operation by a user, an output apparatus for outputting data output by the recruitment assistance apparatus 4, a communication apparatus for enabling the recruitment assistance apparatus 4 to communicate with another apparatus, and the like.

The reception section 401 receives a request pertaining to a place of assignment of a subject staff. Here, the request includes information pertaining to a subject staff for whom a user wants to decide a place of assignment. For example, the request includes, but not limited to, a name (or personal ID), an age, a personality, a desired type of work or desired place of assignment, a property, and the like of a subject staff.

The graph generation section 402 refers to the request received by the reception section 401, and generates, based on information which is indicated by the request and which pertains to a subject staff for whom a user wants to decide a place of assignment, a subject staff graph representing that subject staff in the form of graph. Specifically, the graph generation section 402 generates a subject staff graph including (i) a plurality of nodes each pertaining to a skill, a property, or work experience of the subject staff and (ii) links each indicating a relationship between nodes.

The link prediction section 403 calculates, by link prediction using a subject staff graph and the acceptance place graph, a probability that a node which indicates a predetermined property links to a node included in the subject staff graph, the subject staff graph having been generated by the graph generation section 202 and including a plurality of nodes pertaining to the subject staff, and the link prediction being carried out for predicting a relationship between nodes which are not connected to each other by a link in the subject staff graph and the acceptance place graph. Here, the predetermined property is a property that conforms to the request received by the reception section 401, and includes, for example, the above-described business characteristic.

The inference section 405 infers a place of assignment that is of the subject staff and that conforms to the request based on the probability calculated by the link prediction section 403. That is, the inference section 405 infers a candidate place of assignment that is of the subject staff and that conforms to a subject staff request based on a learned model and the request which pertains to a place of assignment of the subject staff and which has been received by the reception section 401. Here, the learned model is a learned model which has learned a relation between (i) at least one selected from the group consisting of a skill and work experience of each of a plurality of persons and (ii) an affiliation of each of the plurality of persons. The inference section 405 carries out the above-described inference based on a result of link prediction by the link prediction section 403, and thereby carries out inference based on the learned model.

The basis generation section 406 generates basis information indicating a basis of inference carried out by the inference section 405. The basis generation section 406 is similar to the basis generation section 209 in the second example embodiment, and therefore detailed descriptions thereof are not repeated.

The output section 407 outputs various kinds of information generated by the recruitment assistance apparatus 4, such as information indicating a candidate place of assignment inferred by the inference section 405. An output destination of the information output by the output section 407 is not particularly limited, as with the output section 210 in accordance with the second example embodiment.

As described above, the recruitment assistance apparatus 4 further includes the link prediction section 403 for calculating, by link prediction using an acceptance place graph and a subject staff graph, a probability that a node indicating a predetermined property links to a node included in the subject staff graph, the subject staff graph including a plurality of nodes pertaining to the subject staff, the acceptance place graph including (i) a plurality of nodes each pertaining to an acceptance place which is likely to accept the subject staff, a skill of each of the plurality of persons, or work experience of each of the plurality of persons and (ii) links each indicating a relationship between nodes, and the link prediction being carried out for predicting a relationship between nodes which are not connected to each other by a link in the subject staff graph and the acceptance place graph, and the inference section 405 infers a candidate place of assignment that is of the subject staff and that conforms to the request based on the probability which has been calculated by the link prediction section 403.

According to the configuration, response information is generated based on a probability that a node indicating a predetermined property links to a node included in the subject staff graph. A probability that a node indicating a predetermined property links to a node included in the subject staff graph indicates a possibility that the subject staff has the predetermined property. Therefore, according to the configuration, it is possible to provide information that is useful for personnel assistance, specifically, information that indicates what property the subject staff is likely to have.

### (Flow of Process)

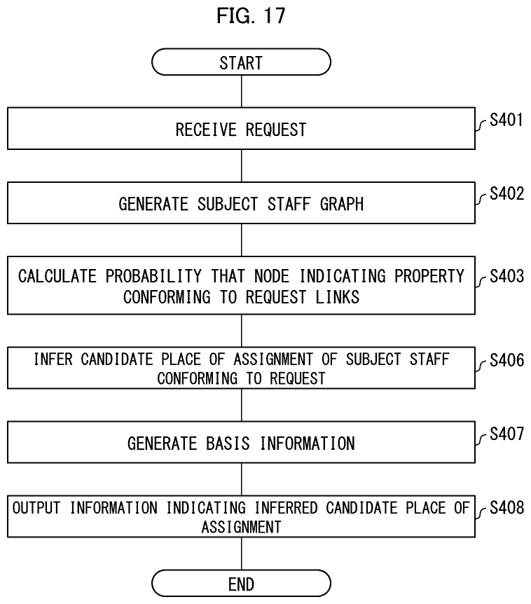

Next, the following description will discuss a flow of a process (recruitment assistance method) carried out by the recruitment assistance apparatus 4, with reference to FIG. 17. FIG. 17 is a flowchart illustrating the flow of the process carried out by the recruitment assistance apparatus 4.

In S401, the reception section 401 receives a request pertaining to a place of assignment of a subject staff. Here, the request includes information pertaining to a subject staff for whom a user wants to decide a place of assignment. For example, the request includes, but not limited to, a name (or personal ID), an age, a personality, a desired type of work or desired place of assignment, a property, and the like of a subject staff.

In S402, the graph generation section 402 generates a subject staff graph based on the information input in S401. For example, in a case where properties of the subject staff are received in S401, the graph generation section 402 may generate a subject staff graph including nodes and links indicating the properties.

In S403, the link prediction section 403 calculates, by link prediction using a subject staff graph and the acceptance place graph, a probability that a node which indicates a predetermined property links to a node included in the subject staff graph, the subject staff graph having been generated in S402 and including a plurality of nodes pertaining to the subject staff, and the link prediction being carried out for predicting a relationship between nodes which are not connected to each other by a link in the subject staff graph and the acceptance place graph.

In S406, the inference section 405 infers a candidate place of assignment that is of the subject staff and that conforms to the request received in S401. Specifically, the inference section 405 infers a place of assignment that is of the subject staff and that conforms to the request based on the probability calculated in S403. For example, in a case where a probability that the subject staff “contributes to new business” is calculated in S403 and the probability is equal to or more than a threshold, the inference section 405 may infer a place of assignment related to the new business as a candidate place of assignment of the subject staff.

In S407, the basis generation section 406 generates basis information indicating a basis of inference carried out in S406. Specifically, the basis generation section 406 may generate basis information which includes a degree of similarity between (i) an attribute of the subject staff and (ii) an attribute of a person who belongs to the candidate place of assignment inferred by the inference section 405 in S406.

In S408, the output section 407 outputs information indicating the place of assignment which has been inferred in S406. At this time, the output section 407 may output also the basis information which has been generated in S407. Thus, the process illustrated in FIG. 17 ends.

In S402, a subject staff graph including an affiliation of the subject staff may be generated. Thus, in the link prediction in S406, it is possible to predict a property that the subject staff will have when the subject staff is assigned to the affiliation. In other words, it is possible to simulate results in cases where a subject staff is assigned to various affiliations. In this case, a place of assignment for which a highest probability of obtaining an intended property has been predicted may be inferred as a candidate place of assignment of the subject staff.

### Variation

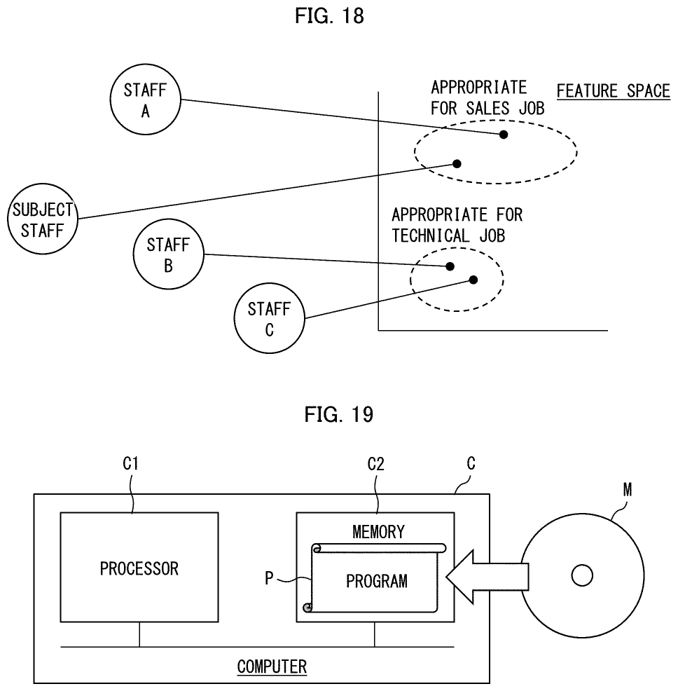

As described above, by using the subject staff graph and the acceptance place graph, it is possible to predict, by link prediction, a property that can link to the corresponding staff graph. Prediction of a property of the subject staff can also be carried out by a method other than link prediction. This will be described with reference to FIG. 18. FIG. 18 is a diagram for describing an example in which a property of a subject staff is predicted based on a feature quantity calculated from a subject staff graph and an acceptance place graph. FIG. 18 illustrates existing employee graphs of existing employees (staffs) A through C and a subject staff graph of the subject staff. Note that nodes and links included in these graphs are not illustrated.

Here, it is possible to calculate a feature quantity for each existing employee by multiplying a feature quantity of each node included in the existing employee graph by a weight corresponding to a link connected to that node, and adding up the weighted feature quantities. Therefore, by carrying out learning in which the weight is updated so that a calculated feature quantity corresponds to a property of the existing employee, it is possible to predict a property of a subject staff from a feature quantity of a subject staff graph which has been calculated while applying the weight.

For example, in the example of FIG. 18, a feature quantity calculated from the existing employee graph of the staff A who has been found to be appropriate for a sales job is learned to fall within a range corresponding to a property of “appropriate for sales job” in a feature space. Moreover, feature quantities calculated from the existing employee graphs of the staff B and the staff C who have been found to be appropriate for a technical job are learned to fall within a range corresponding to a property “appropriate for technical job” in the feature space.

In this case, if a feature quantity calculated from the subject staff graph is included within the range corresponding to the property “appropriate for sales job” as illustrated in FIG. 18, it is possible to predict that the subject staff has the property “appropriate for sales job”. Such a property prediction method can be applied as an alternative method to the method of property prediction in the above-described example embodiments.

### Software Implementation Example

Some or all of the functions of each of the recruitment assistance apparatuses 1, 2, and 4 (hereinafter, “recruitment assistance apparatus 1, and the like”) may be implemented by hardware such as an integrated circuit (IC chip), or may be implemented by software.

In the latter case, the recruitment assistance apparatus 1, and the like are each realized by, for example, a computer that executes instructions of a program that is software realizing the foregoing functions. FIG. 19 illustrates an example of such a computer (hereinafter, referred to as “computer C”). The computer C includes at least one processor C1 and at least one memory C2. The memory C2 stores a program P for causing the computer C to function as the recruitment assistance apparatus 1, and the like. In the computer C, the processor C1 reads the program P from the memory C2 and executes the program P, so that the functions of the recruitment assistance apparatus 1, and the like are realized.

Examples of the processor C1 include a central processing unit (CPU), a graphics processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### Supplementary Note 1

A recruitment assistance apparatus including: a reception means for receiving a request pertaining to a place of assignment of a subject staff; an inference means for inferring a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and an output means for outputting information indicating the candidate place of assignment which has been inferred by the inference means.

According to the configuration, a request pertaining to a place of assignment of a subject staff is received. Then, a candidate place of assignment that is of the subject staff and that conforms to the request is inferred with use of a learned model which has learned a relation between (i) at least one selected from the group consisting of a skill and work experience of each of a plurality of persons and (ii) an affiliation of each of the plurality of persons. Thus, it is possible to infer a candidate place of assignment that is of the subject staff and that conforms to the request while taking into consideration various kinds of information pertaining to an acceptance place. Therefore, according to the configuration, it is possible to suitably carry out personnel assistance for a subject staff while taking into consideration various kinds of information pertaining to an acceptance place.

### Supplementary Note 2

The recruitment assistance apparatus according to supplementary note 1, further including: a basis information generation means for generating, as a basis of inference, basis information that includes a degree of similarity between (i) an attribute of the subject staff and (ii) an attribute of a person who belongs to the candidate place of assignment which has been inferred by the inference means, the output means further outputting the basis information.

According to the configuration, basis information is generated which includes a degree of similarity between (i) an attribute of the subject staff and (ii) an attribute of a person who belongs to the inferred candidate place of assignment. Thus, a user can refer to a candidate place of assignment while taking into consideration a basis thereof. In particular, it is important to secure transparency in personnel matters, and therefore the feature of being capable of generating basis information brings about a great advantage.

### Supplementary Note 3

The recruitment assistance apparatus according to supplementary note 1 or 2, in which: the learned model is an acceptance place graph that includes (i) a plurality of nodes each pertaining to an acceptance place which is likely to accept the subject staff, a skill of each of the plurality of persons, or work experience of each of the plurality of persons and (ii) links each indicating a relationship between nodes.

According to the configuration, a staff node which links to a node included in the subject staff graph is predicted from among staff nodes in the acceptance place graph, and a candidate place of assignment is inferred based on the predicted staff node. How the subject staff is related to which staff at the acceptance place is useful information for a personnel matter of the subject staff. Therefore, according to the configuration, personnel assistance is realized while taking into consideration a staff who is related to the subject staff at the acceptance place.

### Supplementary Note 4

The recruitment assistance apparatus according to supplementary note 3, further including: a link prediction means for predicting, by link prediction using a subject staff graph including a plurality of nodes pertaining to the subject staff and the acceptance place graph, a staff node which links to a node included in the subject staff graph from among staff nodes which are included in the acceptance place graph and which indicate respective staffs belonging to the acceptance place, the link prediction being carried out for predicting a relationship between nodes which are not connected to each other by a link in the subject staff graph and the acceptance place graph, the inference means inferring a candidate place of assignment that is of the subject staff and that conforms to the request on the basis of the staff node which has been predicted by the link prediction means.

According to the configuration, a staff node which links to a node included in the subject staff graph is predicted from among staff nodes in the acceptance place graph, and a candidate place of assignment is inferred based on the predicted staff node. How the subject staff is related to which staff at the acceptance place is useful information for a personnel matter of the subject staff. Therefore, according to the configuration, personnel assistance is realized while taking into consideration a staff who is related to the subject staff at the acceptance place.

### Supplementary Note 5

The recruitment assistance apparatus according to supplementary note 4, in which: the subject staff graph includes (i) a plurality of nodes each pertaining to a skill or work experience of the subject staff and (ii) links each indicating a relationship between nodes.

According to the configuration, it is possible to infer a candidate place of assignment while taking into consideration not only a skill and work experience of the subject staff but also a relationship between those.

### Supplementary Note 6

The recruitment assistance apparatus according to supplementary note 4 or 5, in which: the link prediction means predicts, by the link prediction, a similar staff who is similar to the subject staff from among the staffs who belong to the acceptance place; and the recruitment assistance apparatus further includes an identification means for identifying, from among the staffs belonging to the acceptance place, a congenial staff who is indicated to be congenial to the similar staff by nodes and links included in the acceptance place graph.

According to the configuration, a staff node which indicates a similar staff similar to the subject staff is predicted, and a congenial staff who is indicated, by the nodes and the links included in the acceptance place graph, to be congenial to the similar staff is identified. The congenial staff who is congenial to the similar staff is more likely to be congenial also to the subject staff. That is, according to the configuration, it is possible to identify a congenial staff who is more likely to be congenial to the subject staff from among the staffs belonging to the acceptance place. Therefore, according to the configuration, it is possible to provide a determination basis useful for determining congeniality between the subject staff and the acceptance place.

### Supplementary Note 7

The recruitment assistance apparatus according to supplementary note 6, further including: a congeniality determination means for determining congeniality between the subject staff and the acceptance place based on a degree of similarity that indicates a degree to which the congenial staff is similar to each of the staffs belonging to the acceptance place.

An acceptance place to which staffs similar to the congenial staff belong is more likely to be congenial to the subject staff. In view of this, according to the configuration, congeniality between the subject staff and the acceptance place is determined based on a degree of similarity that indicates a degree to which the congenial staff is similar to each of the staffs belonging to the acceptance place. Thus, it is possible to precisely determine congeniality between the subject staff and the acceptance place.

### Supplementary Note 8

The recruitment assistance apparatus according to supplementary note 6, further including: a congeniality determination means for identifying a department to which the congenial staff belongs from among a plurality of departments included in the acceptance place, and determining congeniality between the department and the subject staff based on a degree of similarity that indicates a degree to which the congenial staff is similar to each of staffs belonging to the department.

A department to which the congenial staff belongs is more likely to be congenial to the subject staff and, if a staff similar to the congenial staff belongs to that department, such a department is more likely to be further congenial to the subject staff. In view of this, according to the configuration, a department to which the congenial staff belongs is identified, and congeniality between the department and the subject staff is determined based on a degree of similarity indicating a degree to which the congenial staff is similar to each of staffs belonging to the department. Thus, it is possible to precisely determine congeniality between the subject staff and a department at the acceptance place.

### Supplementary Note 9

The recruitment assistance apparatus according to supplementary note 8, in which: the congeniality determination means determines congeniality between each of a plurality of subject staffs and each of the plurality of departments; and the recruitment assistance apparatus further includes a recommendation means for deciding, for each of the plurality of subject staffs, a department to be recommended as an acceptance place for that subject staff based on a result of the determination of the congeniality.

According to the configuration, congeniality between each of the plurality of subject staffs and each of the plurality of departments is determined, and a department to be recommended as an acceptance place is decided for each of the plurality of subject staffs based on the determination result. Thus, it is possible to recommend a department at the acceptance place while taking into consideration congeniality between each department and each subject staff.

### Supplementary Note 10

The recruitment assistance apparatus according to supplementary note 1 or 2, further including: a link prediction means for identifying a staff or a department that is at an acceptance place which is likely to accept the subject staff and that has a predetermined relationship with the subject staff by link prediction using an acceptance place graph and a subject staff graph including a plurality of nodes pertaining to the subject staff, the acceptance place graph including (i) a plurality of nodes each pertaining to the acceptance place, a skill of each of the plurality of persons, or work experience of each of the plurality of persons and (ii) links each indicating a relationship between nodes, and the link prediction being carried out for predicting a relationship between nodes which are not connected to each other by a link in the subject staff graph and the acceptance place graph, the inference means inferring a candidate place of assignment that is of the subject staff and that conforms to the request based on the staff or the department at the acceptance place which has been identified by the link prediction means.

According to the configuration, a staff or a department that is at the acceptance place and that has a predetermined relationship with the subject staff is identified, and a candidate place of assignment which is of the subject staff and which conforms to the request is inferred based on the staff or the department. Information pertaining to a staff or a department having a predetermined relationship with the subject staff is information useful for a personnel matter of the subject staff. Therefore, according to the configuration, it is possible to precisely carry out personnel assistance for the subject staff.

### Supplementary Note 11

The recruitment assistance apparatus according to supplementary note 1 or 2, further including: a link prediction means for calculating, by link prediction using an acceptance place graph and a subject staff graph, a probability that a node indicating a predetermined property links to a node included in the subject staff graph, the subject staff graph including a plurality of nodes pertaining to the subject staff, the acceptance place graph including (i) a plurality of nodes each pertaining to an acceptance place which is likely to accept the subject staff, a skill of each of the plurality of persons, or work experience of each of the plurality of persons and (ii) links each indicating a relationship between nodes, and the link prediction being carried out for predicting a relationship between nodes which are not connected to each other by a link in the subject staff graph and the acceptance place graph, the inference means inferring a candidate place of assignment that is of the subject staff and that conforms to the request based on the probability which has been calculated by the link prediction means.

According to the configuration, response information is generated based on a probability that a node indicating a predetermined property links to a node included in the subject staff graph. A probability that a node indicating a predetermined property links to a node included in the subject staff graph indicates a possibility that the subject staff has the predetermined property. Therefore, according to the configuration, it is possible to provide information that is useful for personnel assistance, specifically, information that indicates what property the subject staff is likely to have.

### Supplementary Note 12

A recruitment assistance method including: receiving, by a computer, a request pertaining to a place of assignment of a subject staff; inferring, by the computer, a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and outputting, by the computer, information indicating the candidate place of assignment which has been inferred.

According to the configuration, it is possible to bring about an example advantage similar to that brought about by supplementary note 1.

### Supplementary Note 13

A recruitment assistance program for causing a computer to carry out: a process of receiving a request pertaining to a place of assignment of a subject staff; a process of inferring a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and a process of outputting information indicating the candidate place of assignment which has been inferred.

### Additional Remark 3

Furthermore, some of or all of the foregoing example embodiments can also be expressed as below.

A recruitment assistance apparatus including at least one processor, the at least one processor carrying out: a reception process of receiving a request pertaining to a place of assignment of a subject staff; an inference process of inferring a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and an output process of outputting information indicating the candidate place of assignment which has been inferred.

Note that the recruitment assistance apparatus can further include a memory. The memory can store a program for causing the at least one processor to carry out the reception process, the inference process, and the output process. The program can be stored in a computer-readable non-transitory tangible storage medium.

### REFERENCE SIGNS LIST

1, 2, 4: Recruitment assistance apparatus
11: Reception section
12: Inference section
13: Output section
201, 401: Reception section
202, 402: Graph generation section
203, 403: Link prediction section
204: Identification section
205: Congeniality determination section
206: Recommendation section
207: Learning section
208, 405: Inference section
209, 406: Basis generation section
210, 407: Output section

What is claimed is:

1. A recruitment assistance apparatus comprising at least one processor, the at least one processor carrying out:
a reception process of receiving a request pertaining to a place of assignment of a subject staff;
an inference process of inferring a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and
an output process of outputting information indicating the candidate place of assignment which has been inferred in the inference process.

2. The recruitment assistance apparatus according to claim 1, wherein:
the at least one processor further carries out a basis information generation process of generating, as a basis of inference, basis information that includes a degree of similarity between (i) an attribute of the subject staff and (ii) an attribute of a person who belongs to the candidate place of assignment which has been inferred in the inference process; and
in the output process, the at least one processor further outputs the basis information.

3. The recruitment assistance apparatus according to claim 1, wherein:
the learned model is an acceptance place graph that includes (i) a plurality of nodes each pertaining to an acceptance place which is likely to accept the subject staff, a skill of each of the plurality of persons, or work experience of each of the plurality of persons and (ii) links each indicating a relationship between nodes.

4. The recruitment assistance apparatus according to claim 3, wherein:
the at least one processor further carries out a link prediction process of predicting, by link prediction using a subject staff graph including a plurality of nodes pertaining to the subject staff and the acceptance place graph, a staff node which links to a node included in the subject staff graph from among staff nodes which are included in the acceptance place graph and which indicate respective staffs belonging to the acceptance place, the link prediction being carried out for predicting a relationship between nodes which are not connected to each other by a link in the subject staff graph and the acceptance place graph; and
in the inference process, the at least one processor infers a candidate place of assignment that is of the subject staff and that conforms to the request on the basis of the staff node which has been predicted in the link prediction process.

5. The recruitment assistance apparatus according to claim 4, wherein:
the subject staff graph includes (i) a plurality of nodes each pertaining to a skill or work experience of the subject staff and (ii) links each indicating a relationship between nodes.

6. The recruitment assistance apparatus according to claim 4, wherein:
in the link prediction process, the at least one processor predicts, by the link prediction, a similar staff who is similar to the subject staff from among the staffs who belong to the acceptance place; and
the at least one processor further carries out an identification process of identifying, from among the staffs belonging to the acceptance place, a congenial staff who is indicated to be congenial to the similar staff by nodes and links included in the acceptance place graph.

7. The recruitment assistance apparatus according to claim 6, wherein:
the at least one processor further carries out a congeniality determination process of determining congeniality between the subject staff and the acceptance place based on a degree of similarity that indicates a degree to which the congenial staff is similar to each of the staffs belonging to the acceptance place.

8. The recruitment assistance apparatus according to claim 6, wherein:
the at least one processor further carries out a congeniality determination process of identifying a department to which the congenial staff belongs from among a plurality of departments included in the acceptance place, and determining congeniality between the department and the subject staff based on a degree of similarity that indicates a degree to which the congenial staff is similar to each of staffs belonging to the department.

9. The recruitment assistance apparatus according to claim 8, wherein:
in the congeniality determination process, the at least one processor determines congeniality between each of a plurality of subject staffs and each of the plurality of departments; and
the at least one processors carries out a recommendation process of deciding, for each of the plurality of subject staffs, a department to be recommended as an acceptance place for that subject staff based on a result of the determination of the congeniality.

10. The recruitment assistance apparatus according to claim 1, wherein:
the at least one processor further carries out a link prediction process of identifying a staff or a department that is at an acceptance place which is likely to accept the subject staff and that has a predetermined relationship with the subject staff by link prediction using an acceptance place graph and a subject staff graph including a plurality of nodes pertaining to the subject staff, the acceptance place graph including (i) a plurality of nodes each pertaining to the acceptance place, a skill of each of the plurality of persons, or work experience of each of the plurality of persons and (ii) links each indicating a relationship between nodes, and the link prediction being carried out for predicting a relationship between nodes which are not connected to each other by a link in the subject staff graph and the acceptance place graph,
in the inference process, the at least one processor infers a candidate place of assignment that is of the subject staff and that conforms to the request based on the staff or the department at the acceptance place which has been identified in the link prediction process.

11. The recruitment assistance apparatus according to claim 1, wherein:
the at least one processor further carries out a link prediction process of calculating, by link prediction using an acceptance place graph and a subject staff graph, a probability that a node indicating a predetermined property links to a node included in the subject staff graph, the subject staff graph including a plurality of nodes pertaining to the subject staff, the acceptance place graph including (i) a plurality of nodes each pertaining to an acceptance place which is likely to accept the subject staff, a skill of each of the plurality of persons, or work experience of each of the plurality of persons and (ii) links each indicating a relationship between nodes, and the link prediction being carried out for predicting a relationship between nodes which are not connected to each other by a link in the subject staff graph and the acceptance place graph,
in the inference process, the at least one processor infers a candidate place of assignment that is of the subject staff and that conforms to the request based on the probability which has been calculated in the link prediction process.

12. A recruitment assistance method comprising:
receiving, by a computer, a request pertaining to a place of assignment of a subject staff;
inferring, by the computer, a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and
outputting, by the computer, information indicating the candidate place of assignment which has been inferred.

13. A computer-readable non-transitory storage medium storing a recruitment assistance program for causing a computer to carry out:
a process of receiving a request pertaining to a place of assignment of a subject staff;
a process of inferring a candidate place of assignment that is of the subject staff and that conforms to the request with use of a learned model which has learned a relation between (i) at least one selected from the group consisting of a skill and work experience of each of a plurality of persons and (ii) an affiliation of each of the plurality of persons; and
a process of outputting information indicating the candidate place of assignment which has been inferred.
